(19) United States
(12) Patent Application Publication
(10) Pub. No.: US 2016/0164343 A1
(43) Pub. Date: Jun. 9, 2016

(54) Power Transmission Device

(71) Applicant: HITACHI, LTD., Tokyo (JP)

(72) Inventors: Kazunori HARA, Tokyo (JP); Makoto KATAGISHI, Tokyo (JP); Hiroshi SHINODA, Tokyo (JP); Takahide TERADA, Tokyo (JP)

(21) Appl. No.: 14/904,731

(22) PCT Filed: Sep. 4, 2013
(86) PCT No.: PCT/JP2013/073837

§ 371 Date: Jan. 13, 2016

(51) Int. Cl. H02J 50/12

(52) U.S. Cl. CPC H02J 50/12

(57) ABSTRACT

A power transmission device has a short height and a small size and is capable of transmitting high power with high efficiency. The power transmission device includes first resonators, second resonators coupled to the first resonators via electromagnetic waves, a primary circuit connected to an input end of the first resonator, and a secondary circuit connected to an output end of the second resonator. The first resonator is insulated from the second resonator. Output impedance of the primary circuit is different from input impedance of the secondary circuit. Impedance matching is performed between the output impedance of the primary circuit and impedance in the case of viewing the first resonator side from the input end of the first resonator, and impedance matching is performed between the input impedance of the secondary circuit and impedance in the case of viewing the second resonator side from the output end of the second resonator.

### TECHNICAL FIELD

The present invention relates to a power transmission device that transmits power between two circuits via electromagnetic waves, and particularly relates to the power transmission device in which the two circuits have different reference potential.

### BACKGROUND ART

PTL 1 discloses a configuration in which power is transmitted from a primary circuit to a secondary circuit. via a coreless transformer between the primary circuit and the secondary circuit which have different reference potential. The careless transformer has first and second coils each formed by spirally turning a foil-like conductor (hereinafter referred to as foil conductor coil), and the first and second coils are arranged facing each other, interposing an insulator. Further, in order to improve coupling efficiency between the foil conductor coils, a resonance circuit is formed with the first and second coils and a capacitance component including parasitic capacitance. A ratio of the number of turns between the first coil and the second coil is one-to-one, and respective conductors of the first and second coils overlap 80% or more in a main surface direction, and coupling between the coils can be enhanced.

PTL 2 discloses a configuration in which a capacitance component is connected to a first coil in series in order to improve a power factor. Here, a second coil is selected such that effective resistance of the first coil becomes larger than effective resistance of the single first coil when both ends of the second coil are short-circuited.

### CITATION LIST

### Patent Literatures

PTL 1: JP 2003-244935 A

PTL 2: JP 2009-l36048 A

### SUMMARY OF INVENTION

### Technical Problem

For example, in a power electronics filed, while a switching element that is a component of an inverter, and a gate driver to drive the switching element normally have high potential of several hundred volts or more, a power circuit that supplies power to the gate driver is actuated with low potential of several tens volts or less. Therefore, power is needed to be transmitted between the gate driver and the power circuit while keeping insulation. As such an insulated power supply system, a discrete transformer component that can relatively easily secure insulation and has good performance is widely used in the related arts. However, since there is a problem in which the discrete transformer requires high cost, size, and weight, an alternative means is demanded in a replacement therefor.

To solve this, using the coreless transformer disclosed in PTL 1 may he considered. However, since the careless transformer disclosed in PTL 1 has the one-to-one ratio of the number of turns, input impedance of the first coil and output impedance of the second coil are equal. In general, the impedance of a primary circuit and that of a secondary circuit are different Therefore, impedance mismatching may be caused between the first coil and the primary circuit or between the second coil and the secondary circuit. Power reception in the second coil is largely affected by the impedance mismatching between the respective coils and The respective circuits in addition to Q values of the respective coils and a coupling coefficient between both of the coils. Therefore, there is concern over transmission loss due to the impedance mismatching.

Further, in PTL 2, the impedance of the first coil and the second coil is specified in the view from the first coil. According to PTL 2, same as PTL 1, no special consideration is given to the impedance matching between the first coil and the primary circuit or between the second coil and the secondary circuit.

The present invention is made in view the above-described situations, and one of objects thereof is to provide a power transmission device having a short height and a small size and capable of transmitting high power with high efficiency.

The above-mentioned object and other objects as well as novel characteristics of the present invention will be apparent from the description of the present specification and the accompanying drawings.

### Solution to Problem

The following is a brief description. of an outline of typical embodiments among the inventions disclosed in the present application.

The power transmission device according to the present embodiment includes a first resonator, a second resonator coupled to the first resonator via electromagnetic waves, a primary, circuit connected to an input end of the first resonator and configured to supply power to the first resonator, and a secondary circuit connected to an output end of the second resonator and configured to be supplied with power from the second resonator. The first resonator is insulated from the second resonator. Output impedance of the primary circuit is different from input impedance of the secondary circuit. Impedance matching is performed between the output impedance of the primary circuit and impedance in the case of viewing the first resonator side from the input end of the first resonator, and impedance matching is performed between the input impedance of the secondary circuit and impedance in the case of viewing the second resonator side from the output end of the second resonator.

### ADVANTAGEOUS EFFECTS OF INVENTION

Briefly, describing effects obtained from the typical embodiments among the inventions disclosed in the present application, the height/size can be reduced and highly efficient power transmission can be achieved in a power transmission device that transmits high power.

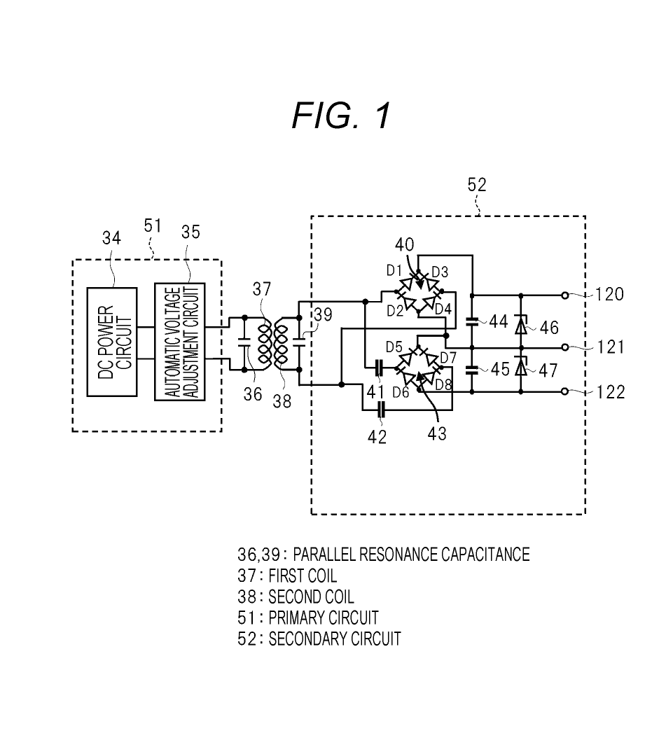

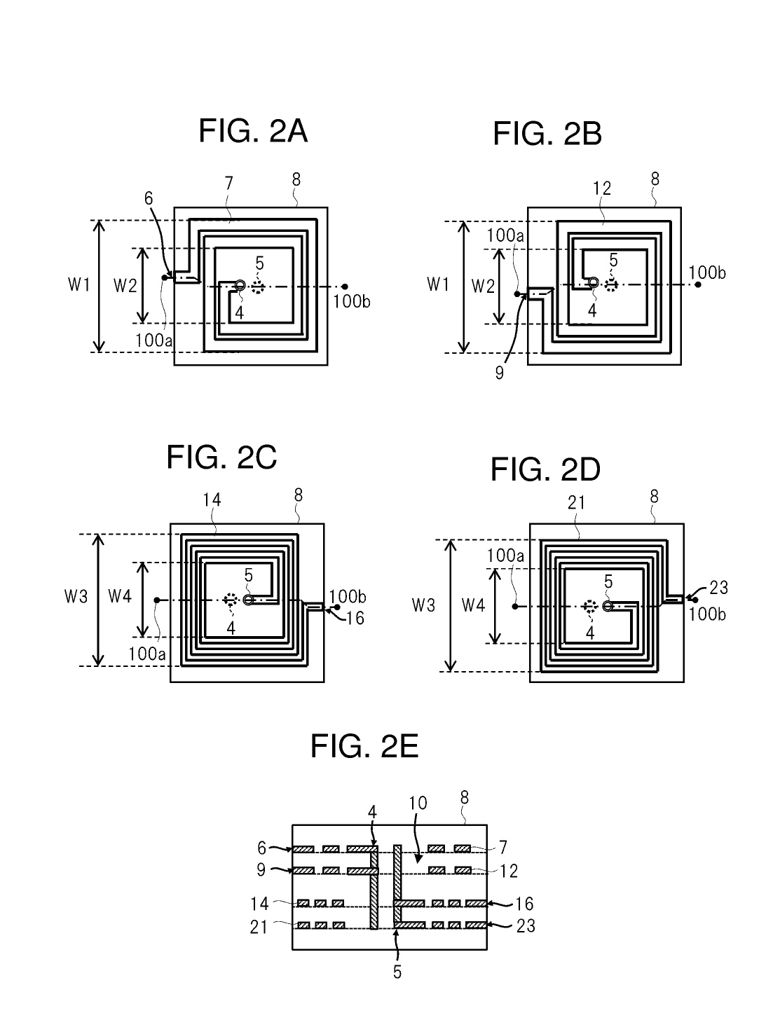

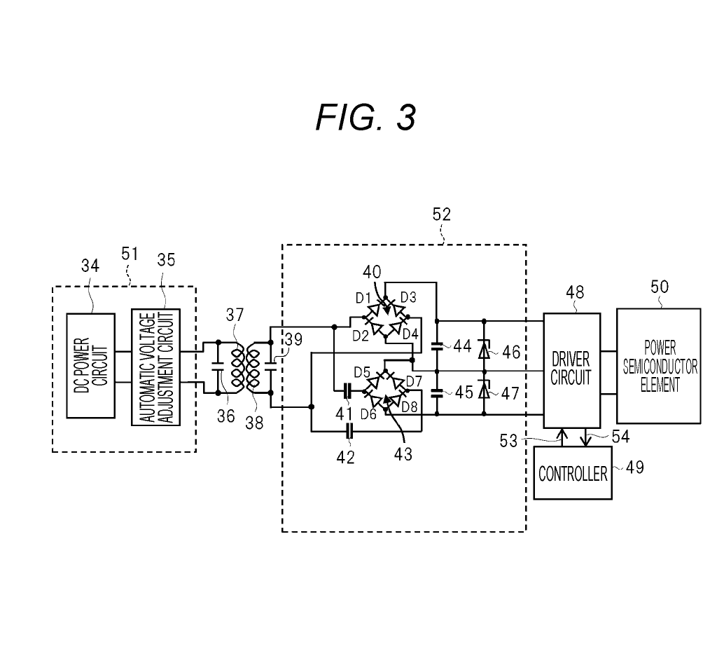

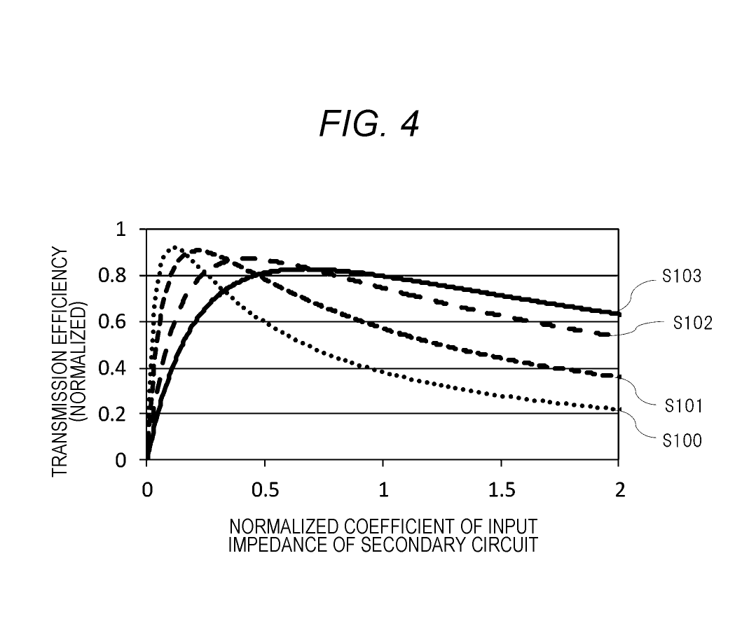

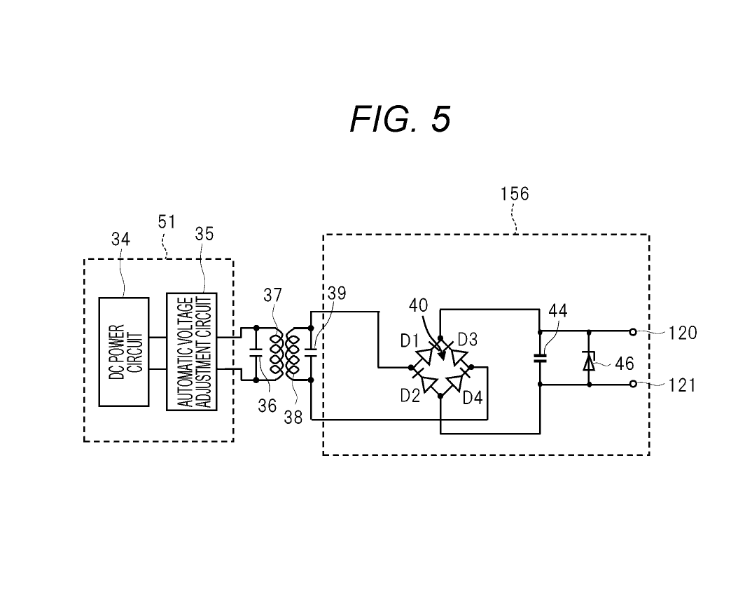

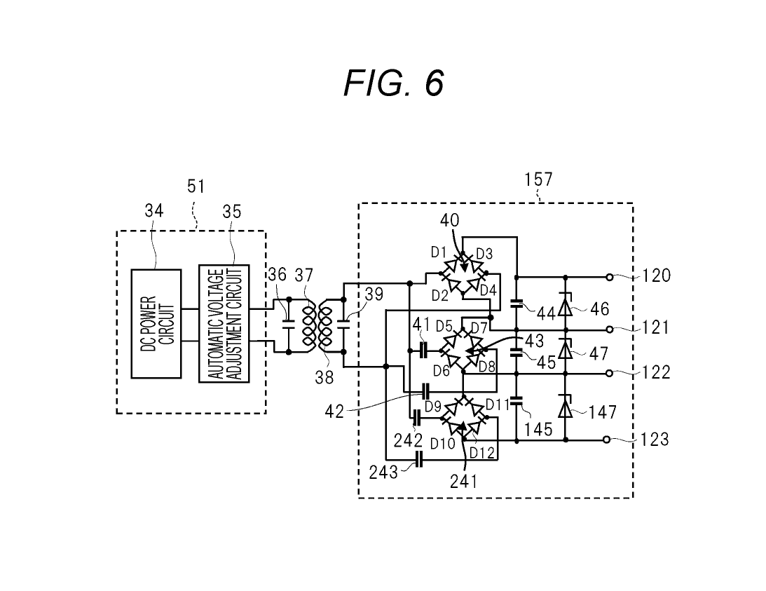

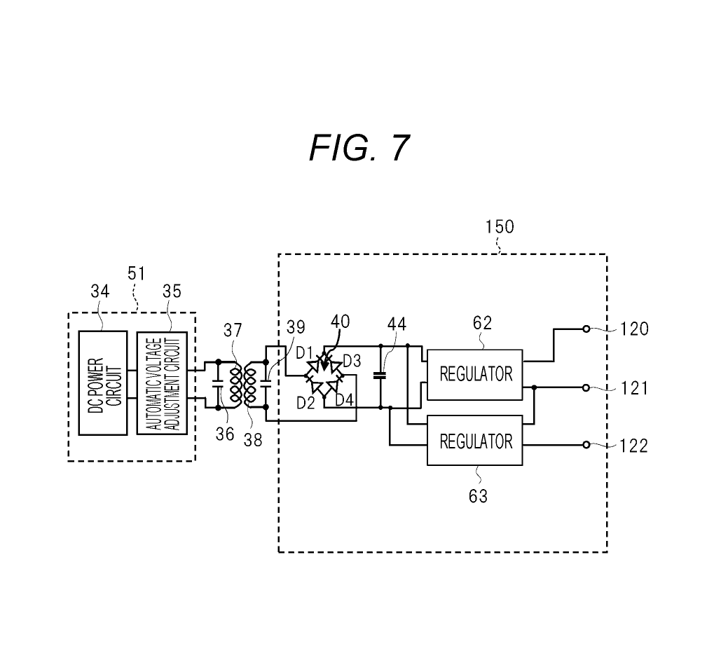

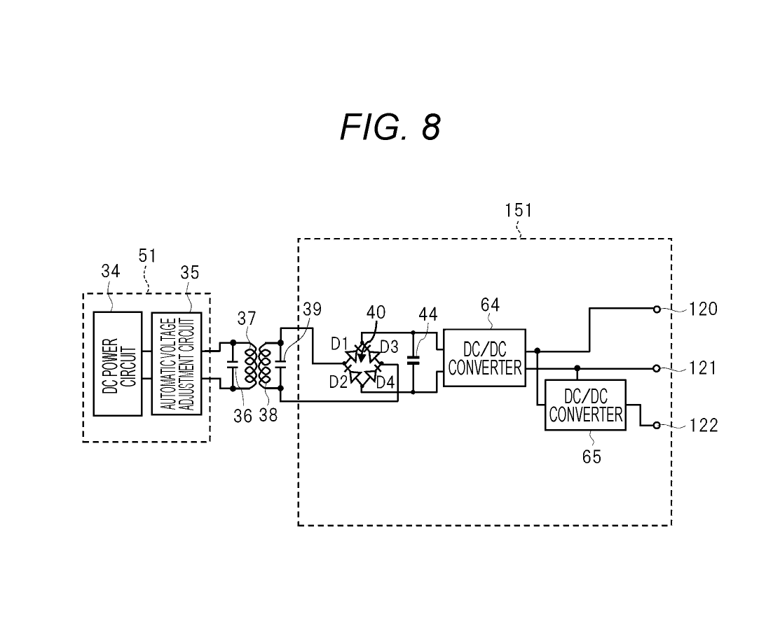

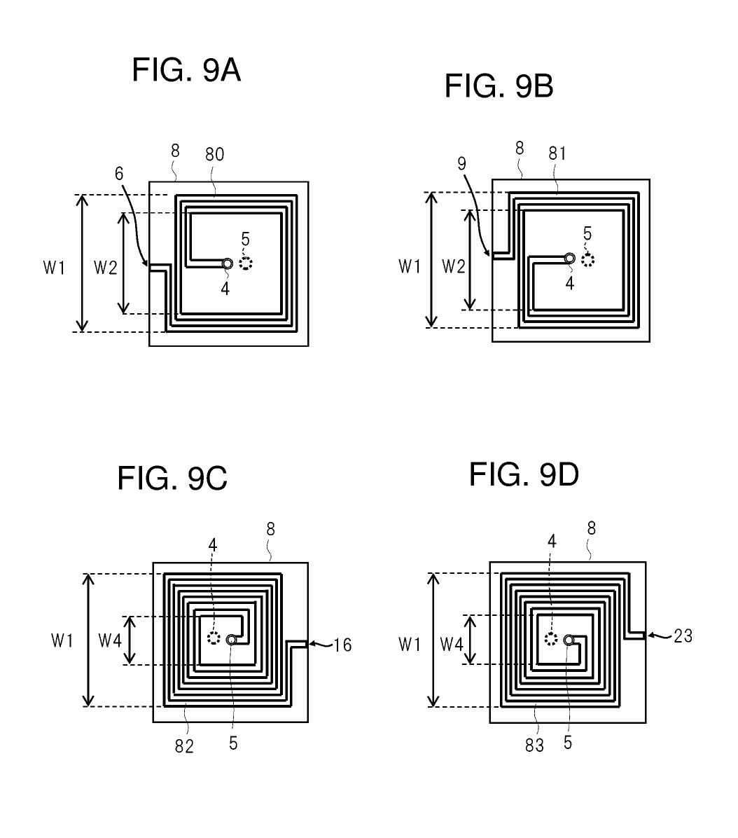

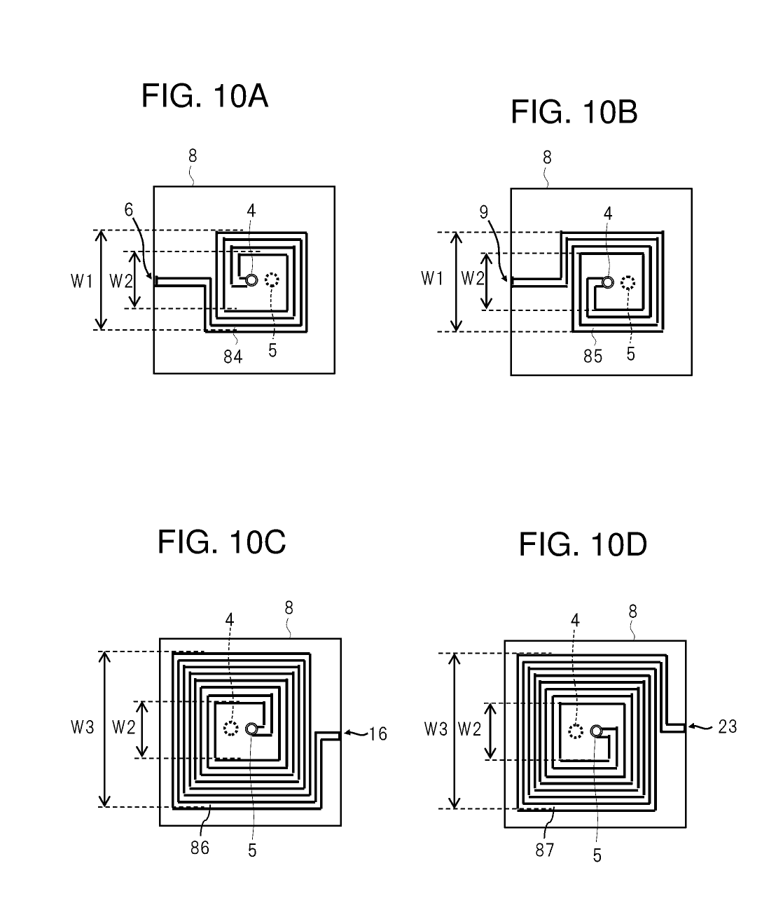

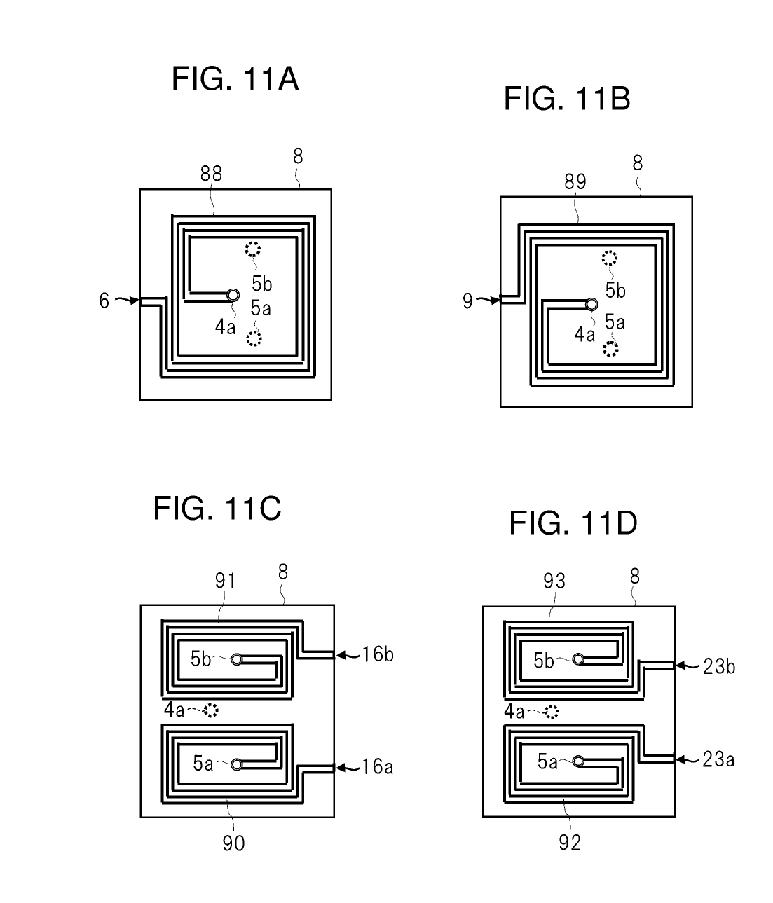

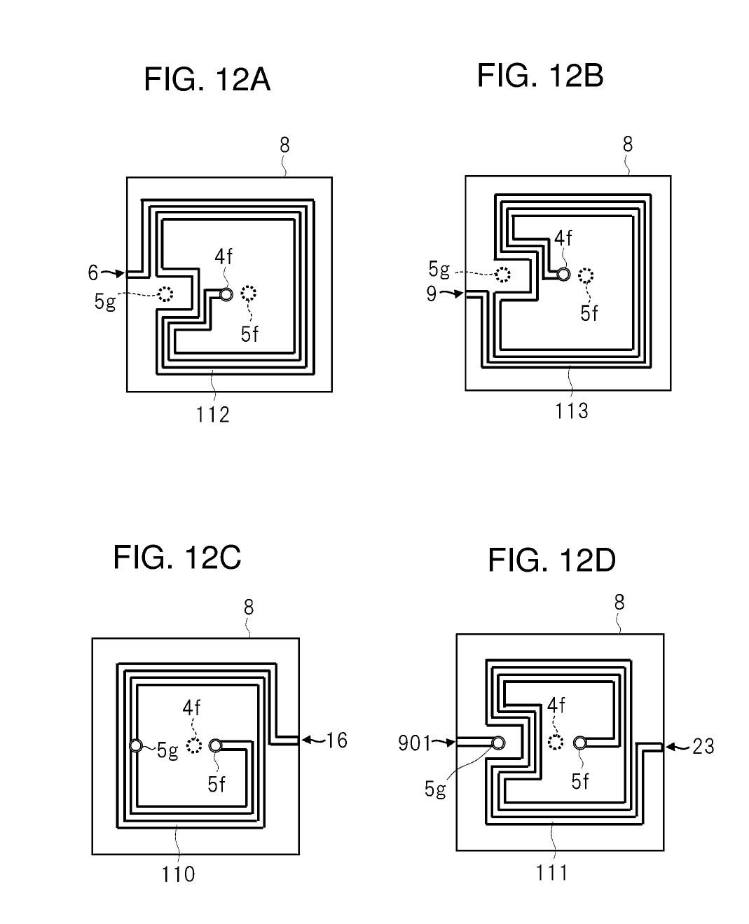

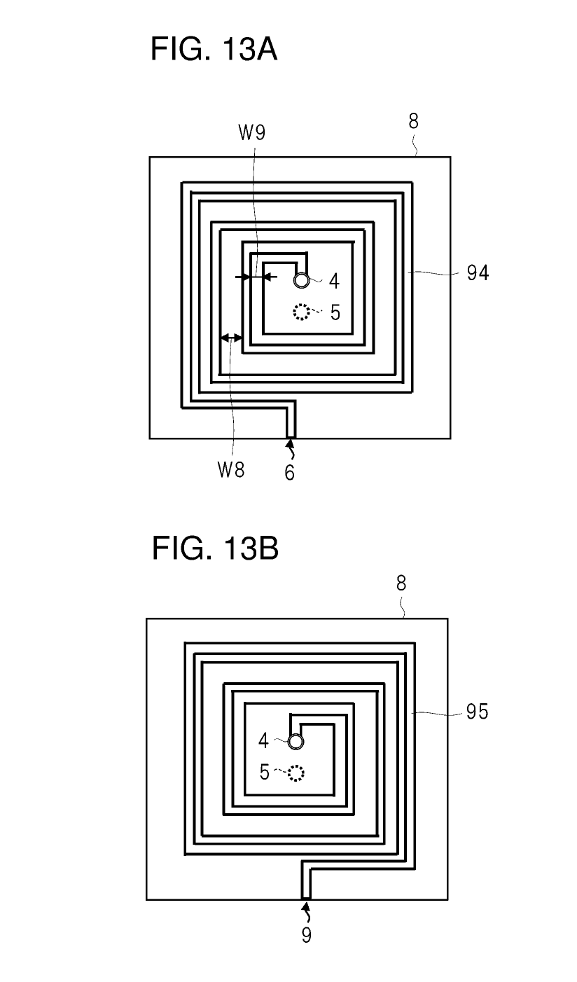

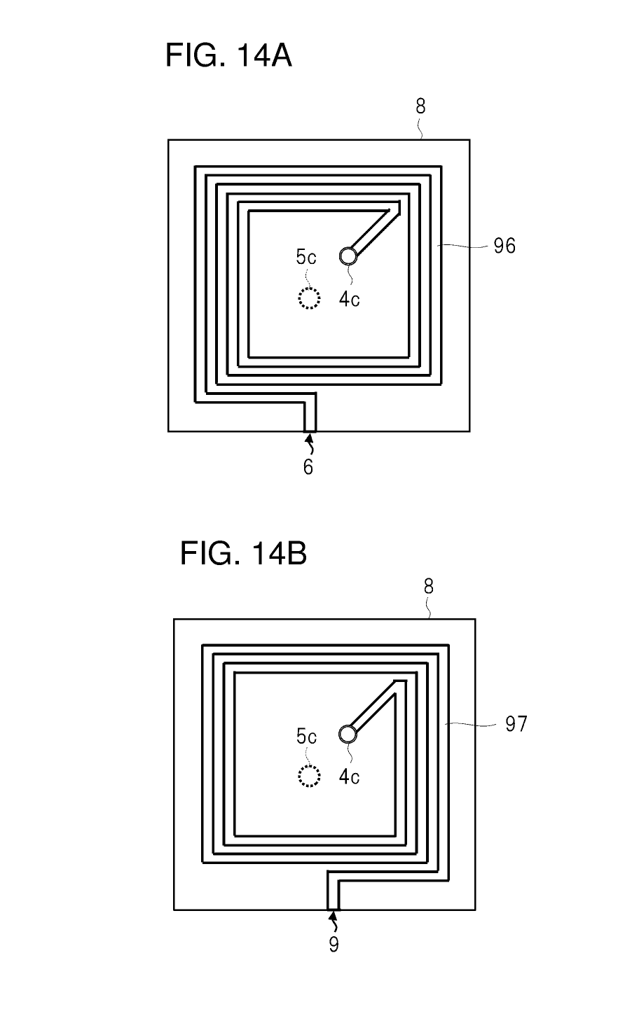

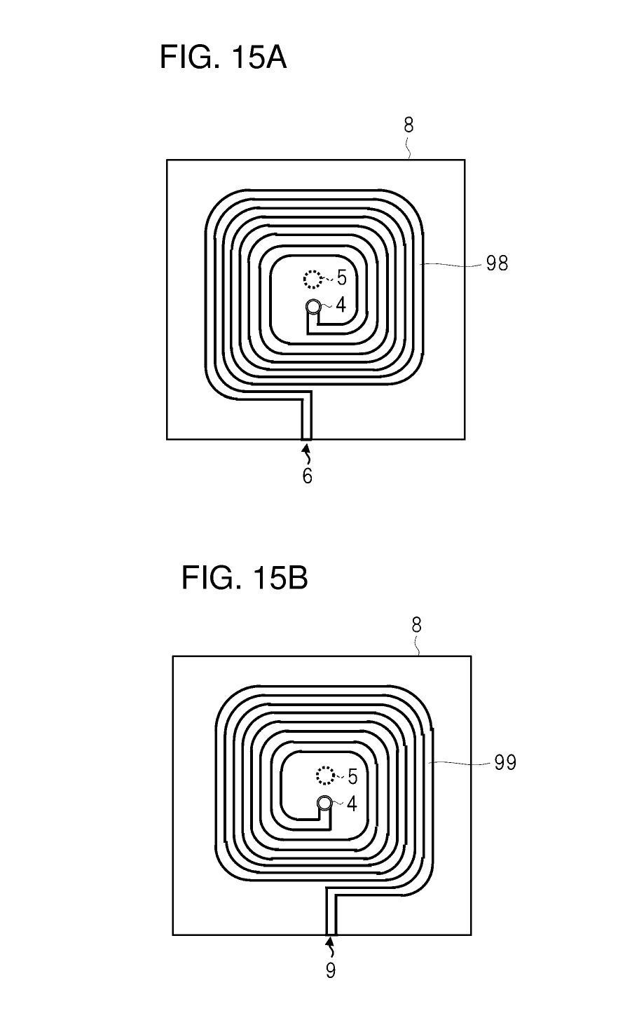

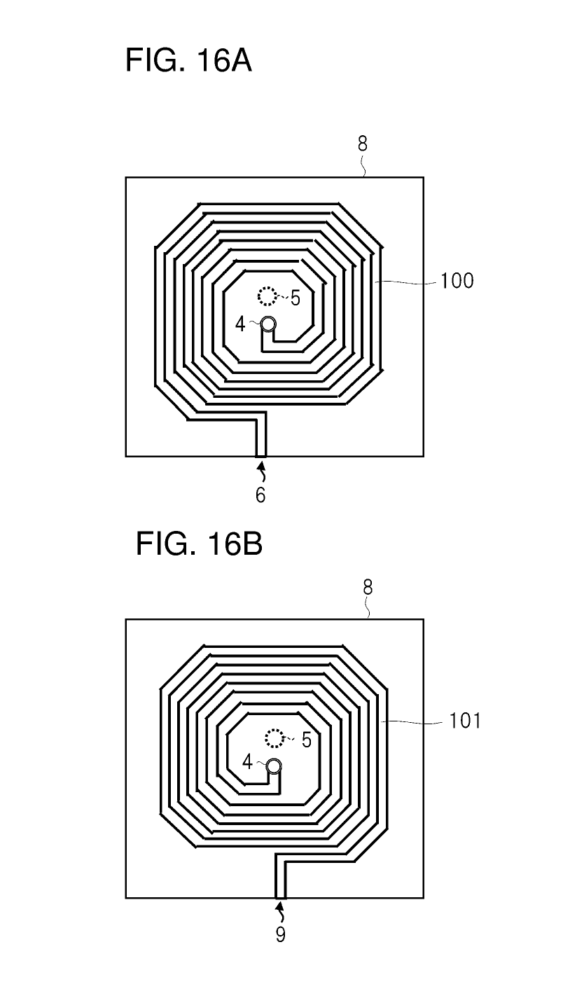

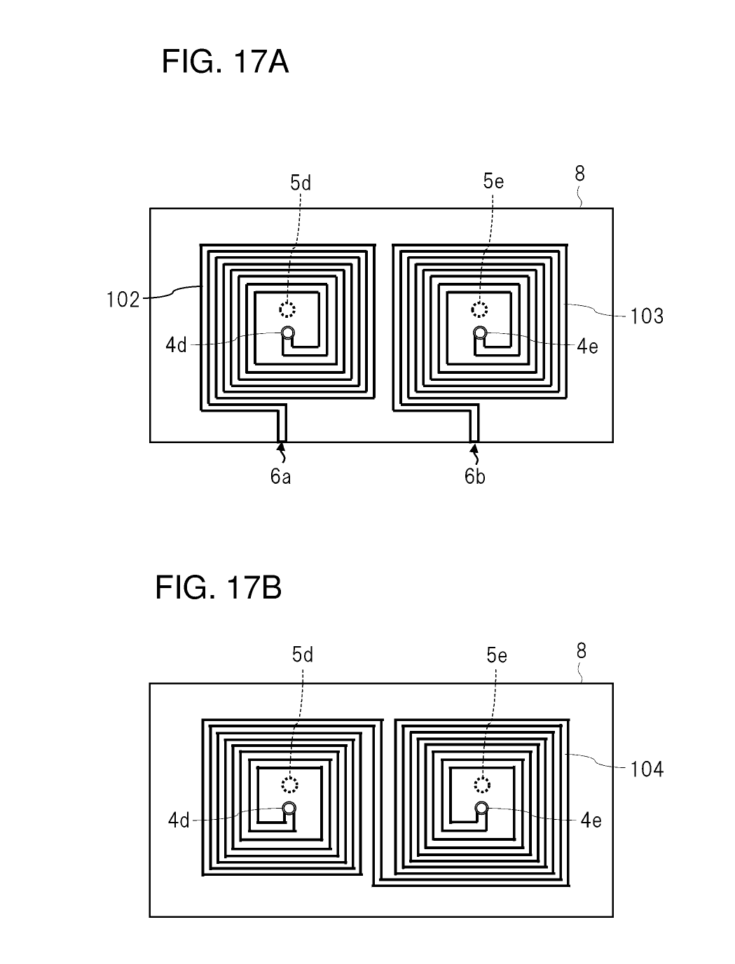

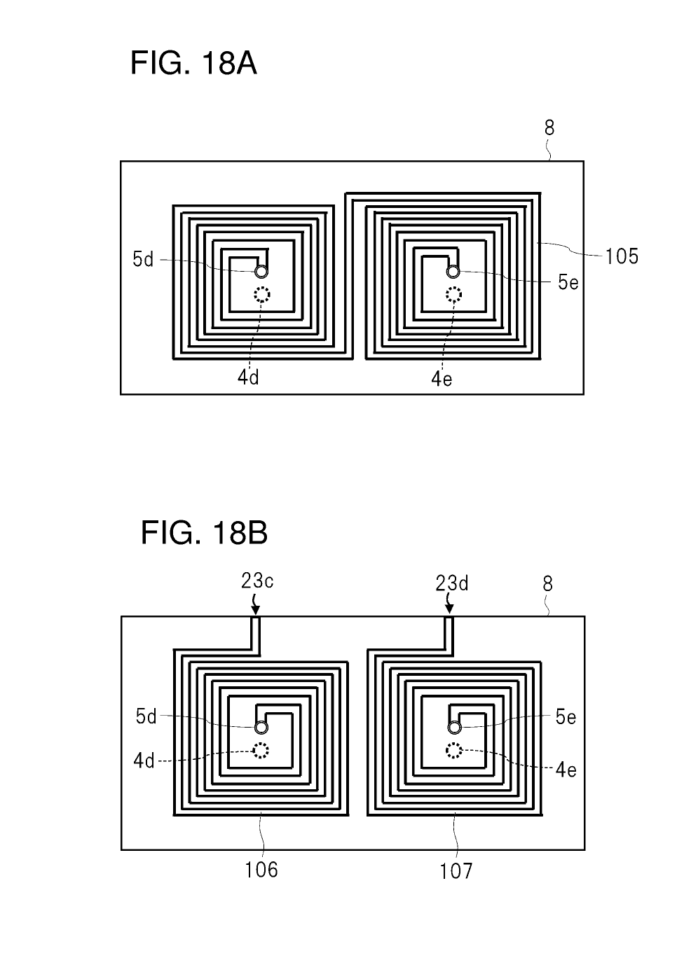

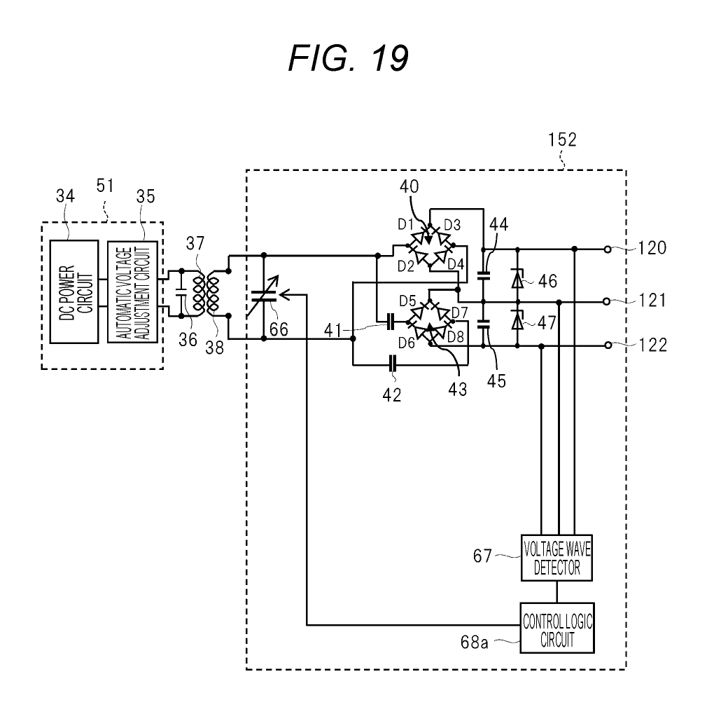

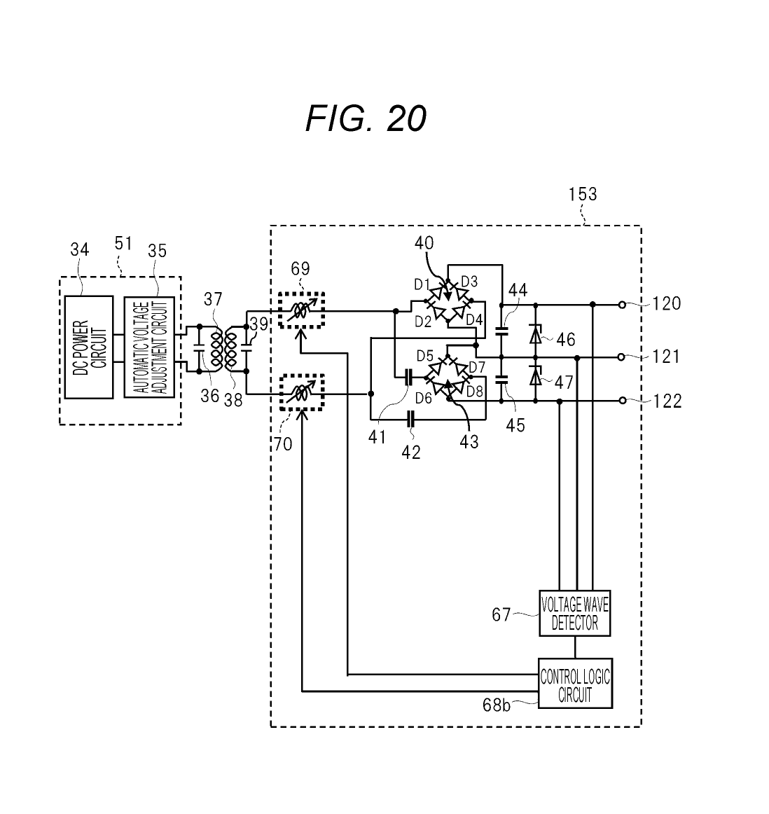

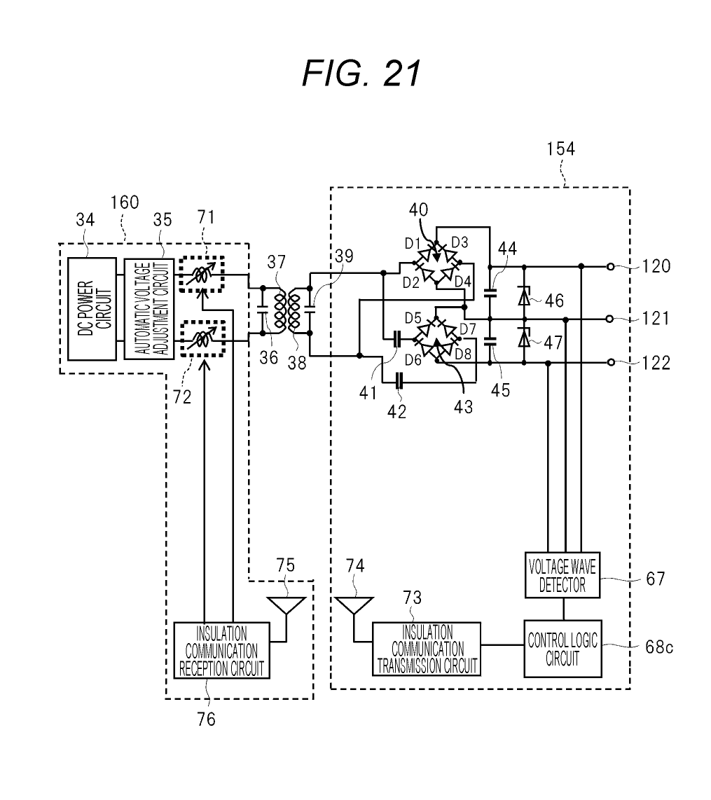

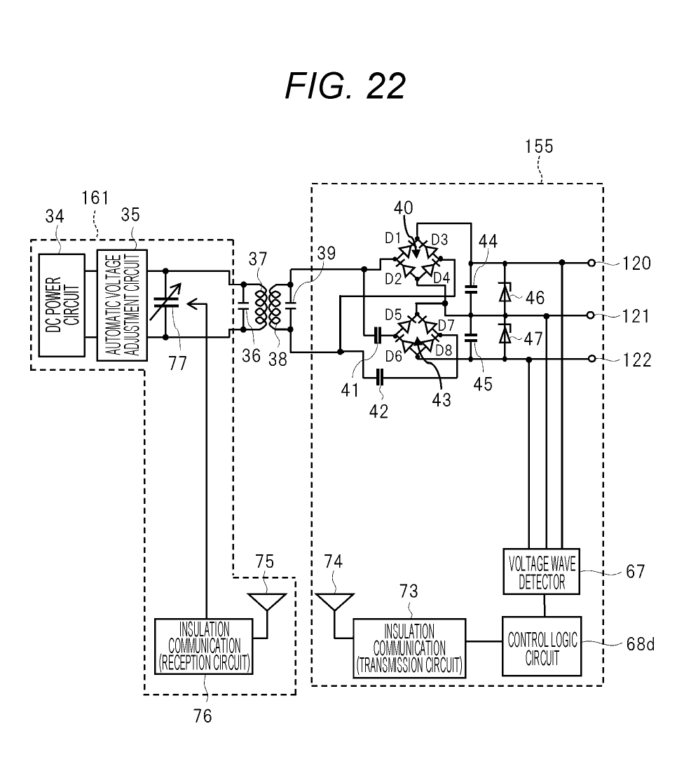

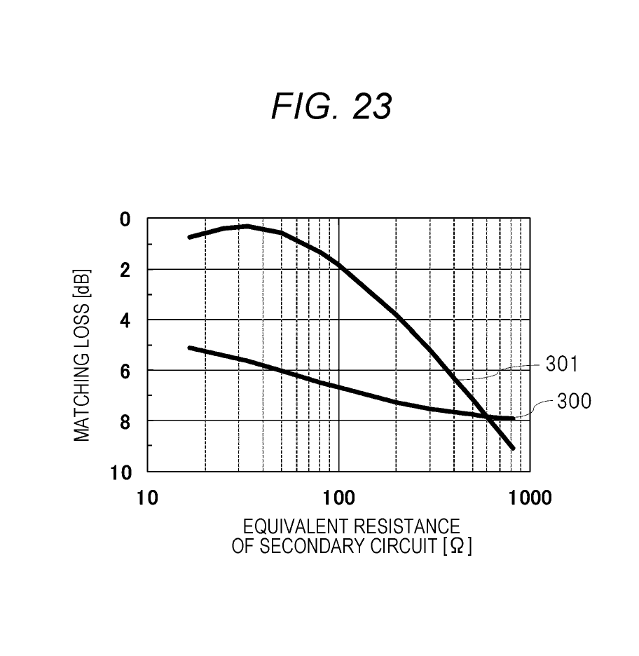

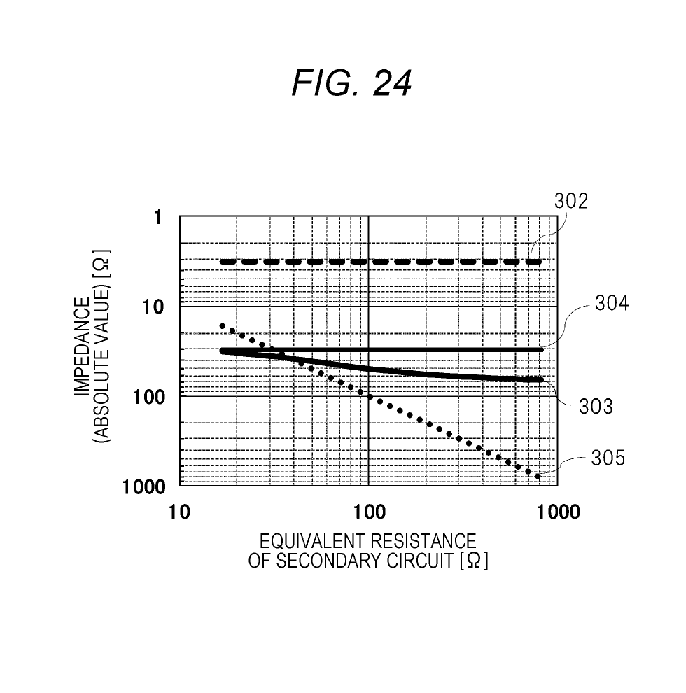

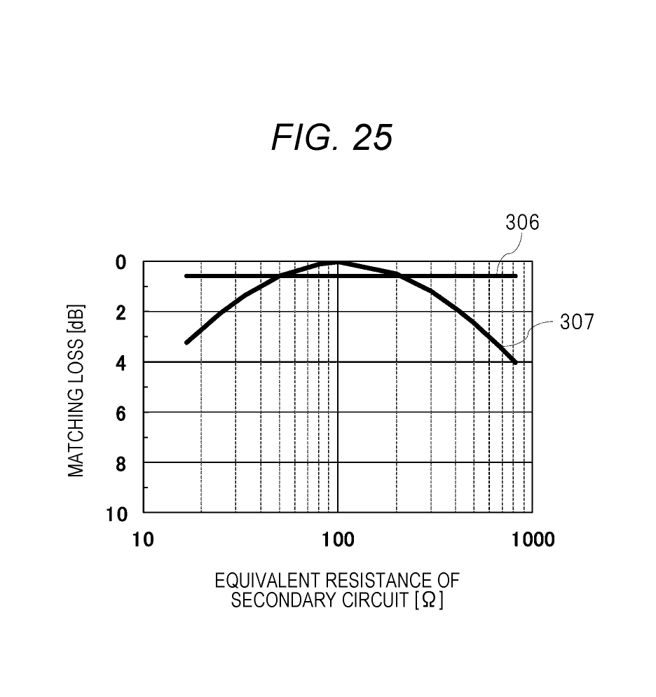

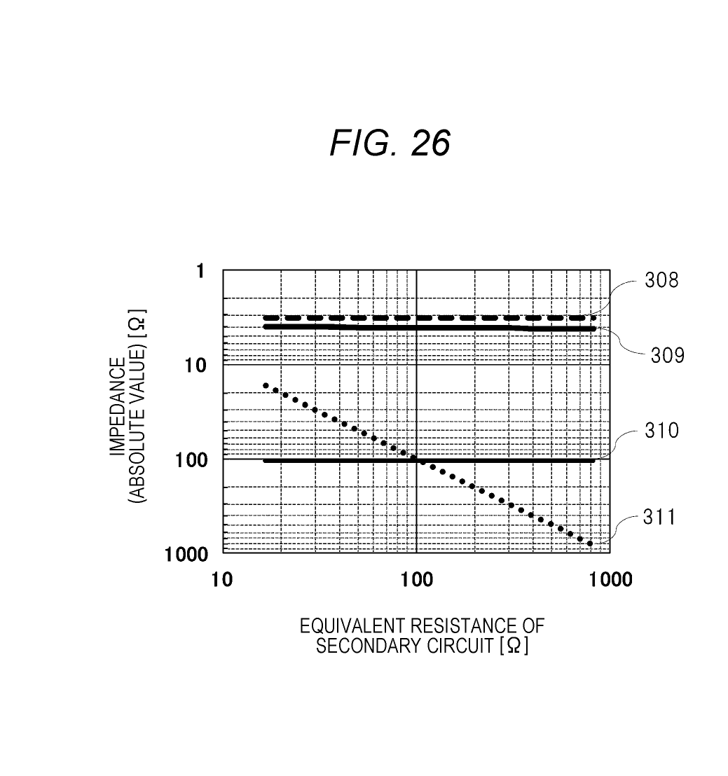

### BRIEF DESCRIPTION OF DRAWINGS

[FIG. 1] FIG. 1 is a circuit diagram schematically illustrating an exemplary configuration of a main portion in a power transmission device according to a first embodiment of the present invention.

[FIG. 2] FIGS. 2(a) to 2(e) are diagrams illustrating exemplary structures of first and second coils inside first and second resonators in the power transmission device of FIG. 1.

[FIG. 3] FIG. 3 is a diagram illustrating an exemplary configuration of a power switching element drive system in which the power transmission device in FIG. 1 is applied.

[FIG. 4] FIG. 4 is an explanatory diagram illustrating an exemplary effect in the power transmission device in FIG. 1.

[FIG. 5] FIG. 5 is a circuit diagram schematically illustrating an exemplary configuration in which the number of output terminals is reduced in a main portion of a power transmission device according to a second embodiment of the present invention.

[FIG. 6] FIG. 6 is a circuit diagram schematically illustrating an exemplary configuration in which the number of output terminals is increased in the main portion of the power transmission device according to the second embodiment of the present invention.

[FIG. 7] FIG. 7 is a circuit diagram schematically illustrating an exemplary configuration in which a regulator is used in the main portion of the power transmission device according to the second embodiment of the present invention,

[FIG. 8] FIG. 8 is a circuit diagram schematically illustrating an exemplary configuration in which a DC/DC converter is used in the main portion of the power transmission device according to the second embodiment of the present invention.

[FIG. 9] FIGS. 9(a) to 9(d) are diagrams illustrating exemplary structures in which inner diameters of first and second coils inside first and second resonators are different in a power transmission device according to a third embodiment of the present invention.

[FIG. 10] FIGS. 10(a) to 10(d) are diagrams illustrating exemplary structures in which outer diameters of the first and second coils in the first. and second resonators are different in the power transmission device according to the third embodiment of the present invention.

[FIG. 11] FIGS. 11(a) to 11(d) are diagrams illustrating exemplary structures in which divided coils are applied to the first and second coils inside the first and second resonators in the power transmission device according to the third embodiment of the present invention.

[FIG. 12] FIGS. 12(a) to 12(d) are diagrams illustrating exemplary structures in which a center tap is applied to the first and second coils inside the first and second resonators in the power transmission device according to the third embodiment of the present invention.

[FIG. 13] FIGS. 13(a) and 13(b) are diagrams illustrating exemplary structures in which a line width of the first coil inside the first resonator is devised in the power transmission. device according to the third embodiment of the present invent ion

[FIG. 14] FIGS. 14(a) and 14(b) are diagrams illustrating exemplary structures in which arrangement of a through via hole of the first coil inside the first resonator is devised in the power transmission device according to the third embodiment of the present. invention.

[FIG. 15] FIGS. 15(a) and 15(b) are diagrams illustrating exemplary structures in which a corner portion of the first coil inside the first resonator is devised in the power transmission device according to the third embodiment of the present invention.

[FIG. 16] FIGS. 16(a) and 16(b) are diagrams illustrating exemplary structures in which the corner portion of the first coil inside the first resonator is devised in the power transmission device according to the third embodiment of the present invention.

[FIG. 17] FIGS. 17(a) and 17(b) are diagrams illustrating exemplary structures in which winding in the first coil inside the first resonator is devised in the power transmission device according to the third embodiment of the present invention.

[FIG. 18] FIGS. 18(a) and 18(b) are diagrams illustrating exemplary structures of the second coil inside the second resonators in the power transmission device in FIGS. 17(a) and 17(b).

[FIG. 19] FIG. 19 is a circuit diagram schematically illustrating an exemplary configuration in which an electronic variable capacitance is applied to the main portion in a power transmission device according to a fourth embodiment of the present invention.

[FIG. 20] FIG. 20 is a circuit diagram schematically illustrating an exemplary configuration in which an electronic variable inductor is applied to the main portion in the power transmission device according to the fourth embodiment of the present invention.

[FIG. 21] FIG. 21 is a circuit diagram schematically illustrating an exemplary configuration different from FIG. 20, in which the electronic variable inductor is applied to the main portion in the power transmission device according to the fourth embodiment of the present invention.

[FIG. 22] FIG. 22 is a circuit diagram schematically illustrating an exemplary configuration different from FIG. 19, in which the electronic variable capacitance is applied to the main portion in the power transmission device according to the fourth embodiment of the present invention.

[FIG. 23] FIG. 23 is an explanatory diagram illustrating exemplary impedance matching losses in the case where number of turns and a shape of the first coil are same as the second coil in the power transmission device of FIG. 1.

[FIG. 24] FIG. 24 is an explanatory diagram illustrating exemplary impedance values at respective portions in FIG. 23.

[FIG. 25] FIG. 25 is an explanatory diagram illustrating exemplary impedance matching losses in the case where number of turns in the first. coil is different from that in the second coils in the power transmission device of FIG. 1.

[FIG. 26] FIG. 26 is an explanatory diagram illustrating exemplary impedance values at respective portions in FIG. 25.

### DESCRIPTION OF EMBODIMENTS

In the following embodiments, the invention will be described in a plurality of divided sections or embodiments when necessary for convenience; however, unless particularly otherwise described, the sections or the embodiments are mutually related, and one section or embodiment is in a relation to provide a modification example, details and supplemental explanation, etc. of all or part of the other sections or embodiments. In addition, in the following embodiments, in a case where the numeric values (including number, value, amount, range, etc.) of an element are stated, except for the case where the numeric values are particularly specified or are obviously limited to a specific value in principle, the numeric values are not limited to the stated values, and may be equal to or more or less than the stated values

Furthermore, in the following embodiments, except for the case where components (including component steps and the like) are particularly specified or are obviously considered essential in principle, it is needless to mention that the components are not necessarily essential. Similarly, in the following embodiments, when a shape, a positional relationship, etc. of a component and the like are stated, a shape and the like substantially similar or approximate to the shape and the like are included except for the case where the shape, positional relationship, etc. are particularly specified or are obviously considered in principle not to include the similar or approximate shape and the like. This shall be applied to the above-described numeric values and ranges as well.

Embodiments of the present invention will be described below in detail based on the drawings. In addition, in all of the drawings to describe the embodiments, a same member will be denoted. by a same reference sign and repetition of a description therefor will be omitted.

### First Embodiment

<Configuration of Main Portion of Power Transmission Device>

FIG. 1 is a circuit diagram schematically illustrating an exemplary configuration of a main portion in a power transmission device according to a first embodiment of the present invention. The power transmission device illustrated. in FIG. 1 includes first resonators (36, 37), second resonators (38, 39) coupled to the first resonators via electromagnetic waves, a primary circuit 51, and a secondary circuit 52. The primary circuit 51 includes a DC power circuit 34 and an automatic voltage adjustment circuit 35, and is connected to an input end of the first resonator to supply power to the first resonator. The secondary circuit 52 includes diode bridge circuits 40, 43, capacitance 41, 42, 44, 45, and Zener diodes 46, 47, and is connected to an output end of the second resonator and power is supplied from the second resonator. The first resonator includes a first. coil 37 formed of a multilayer foil conductor and a parallel resonance capacitance 36 connected. thereto in parallel. The second resonator includes a second coil 38 formed of a multilayer foil conductor and a parallel resonance capacitance 39 connected to thereto in parallel.

DC voltage generated by the DC power circuit 34 is converted to predetermined AC voltage by the automatic voltage adjustment circuit 35, and then received in the first coil 37 of the multilayer foil conductor or the parallel resonance capacitance 36. The automatic voltage adjustment circuit 35 is a circuit to receive feedback, for example, from the secondary circuit 52, and control the AC voltage supplied to the first resonator such that predetermined stable voltage can be generated at the secondary circuit 52. The power received in the first coil 37 of the multilayer foil conductor is transmitted to the second coil 38. At is point, an inductance value of the first coil 37 and a capacitance value of the parallel resonance capacitance 36 are set so as to resonate at a predetermined frequency, and an inductance value of the second coil 38 and a capacitance value of the parallel resonance capacitance 39 are also set so as to resonate at a predetermined frequency.

The diode bridge circuit (second diode bridge circuit) 40 is a full-wave rectifier including rectifier diodes D1 to D4, and rectifies power supplied from the output end of the second resonators (38, 39). On the other hand, the diode bridge circuit (first diode bridge circuit) 43 is a full-wave rectifier including rectifier diodes D5 to D8, and rectifies power supplied from the output end of the second resonators (38, 39) via the capacitance 41, 42. The capacitance 41, 42 has a function to set an output voltage level of the diode bridge circuit 43 by an impedance component of the capacitance value in addition to a function to cut a DC voltage component between the diode bridge circuits 40 and 43. For the rectifier diodes D1 to D8, for example, a Schottky barrier diode having forward voltage drop less than a un junction diode and having a fast switching speed, or a fast recovery diode having a short recovery time can be applied.

The diode bridge circuit 43 outputs rectified voltage to a node between output terminals 121, 122 (first output node). A smoothing capacitance (first smoothing capacitance) 45 that smoothens the rectified voltage, and a Zener diode (first clamp circuit) 47 that restricts a voltage between the output terminals 121, 122 to a predetermined voltage or less are connected in parallel between the output terminals 121, 122. In the same manner, the diode bridge circuit 40 outputs rectified voltage to a node between the output terminals 120, 121 (second output node). A smoothing capacitance (second smoothing capacitance) 44 that smoothens rectified voltage, and a Zener diode (second clamp circuit) 46 that restricts a voltage between the output terminals 120, 121 to a predetermined voltage or less are connected in parallel between the output terminals 120, 121.

Here, output impedance of the primary circuit 51 that transmits power is normally smaller than input impedance of the secondary circuit 52 that receives power. As is represented by the above-described PTL 1, a coupling coefficient. between a primary side and secondary side is generally important in order to improve power transmission efficiency. However, in the case where the impedance of the primary circuit 51 thus differs from that of secondary circuit 52, sufficient transmission efficiency may not be obtained only by improving the coupling coefficient. Therefore, here the transmission efficiency indicating a proportion between power received in the secondary circuit 52 and power transmitted from the primary circuit 51 is improved. by securing a coupling coefficient of a certain level between the primary side and the secondary side and further performing impedance matching by means of the first and second resonators.

More specifically, impedance matching is performed between output impedance of the primary circuit 51 and impedance in the case of viewing the first resonators site from the input ends of the first resonators (36, 37) (hereinafter referred to as input impedance of the first resonators). Further, impedance matching is performed between input impedance of the secondary circuit 52 and impedance in the case of viewing the second resonators side from the output ends of the second. resonators (38, 39) (hereinafter referred to as output impedance of the second resonators). Here, as the impedance matching method, the first coil 37 of the first resonator and the second coil 39 of the second. resonator are formed such that the input impedance of the first resonator becomes smaller than the output impedance of the second resonator.

Next, impedance matching will be more specifically described. In the case of defining the output impedance having a complex number of the primary circuit 51 as Z1 and defining the input impedance having a complex number of the first resonators (37, 38) as Z2, a reflection coefficient Γ represented by Expression (1) and matching loss Ploss represented by Expression (2) can be obtained. Note that “*” is a sign indicating a conjugate complex number. Further, the Expressions (1) and (2) can be applied. in the same manner in the case of defining the output impedance having a complex number of the second resonators (38, 39) as Z1 and defining the input impedance having a complex number of the secondary circuit 52 as Z2.

Γ=(Z1−Z*2)/(Z1+Z2) (1)

Ploss=−10 Log10 (1−Γ²) [dB] (2)

In the present embodiment, a definition of impedance matching is that the matching loss Ploss becomes less than 3 dB at an operating frequency. The power transmission device in FIG. 1 is formed such that the matching loss between the primary circuit 51 and the input ends of the first resonators (36, 37) is less than 3 dB, more preferably, less than 1 dB. In the same manner, the power transmission device is formed such that matching loss between the secondary circuit 52 and the output ends of the second resonators (38, 39) is less than 3 dB, more preferably, less than 1 dB.

FIG. 23 is an explanatory diagram illustrating exemplary impedance matching losses in the case where number of turns and a shape of the first coil are same as the second coil in the power transmission device of FIG. 1. A characteristic 301 of impedance matching between the second resonator and the secondary circuit indicates the smallest matching loss when equivalent resistance of the secondary circuit is about 30 Ω, which is preferred. But, a characteristic 300 of impedance matching between. the first resonator and the primary circuit indicates matching loss of 3 dB or more, which is not preferred.

FIG. 24 is an explanatory diagram illustrating exemplary impedance values at respective portions in FIG. 23. FIG. 24 illustrates an output. impedance characteristic 302 of the primary circuit, an input impedance characteristic 303 of the first resonator, an output impedance characteristic 304 of the second resonator, and an input impedance characteristic 305 of the secondary circuit respectively. The output impedance characteristic 304 of the second resonator and the input impedance characteristic 305 of the secondary circuit show equal impedance values when the equivalent resistance of the secondary circuit is about 30 Ω, and preferable impedance matching can be achieved under this condition. However, the input impedance characteristic 303 of the first resonator and the output impedance characteristic 302 of the primary circuit show impedance values which are different by 10 times or more from each other, and preferable impedance matching cannot be achieved.

FIG. 25 is an explanatory diagram illustrating exemplary impedance matching losses in the case where the number of turns in the first. coil is different from that in the second coils in the power transmission device of FIG. 1. FIG. 25 illustrates a characteristic 306 of impedance matching between the first resonator and the primary circuit and a characteristic 307 of impedance matching between the second resonator and the secondary circuit. Here, by reducing the number of turns in the first coil 37 to reduce the input. impedance of the first resonator, the characteristic 306 of impedance matching between the first resonator and the primary circuit 51 shows the matching loss less than 1 dB, and preferable impedance matching is achieved. Further, by increasing the number of turns in the second coil 38 to increase the output impedance of the second resonator, the characteristic 307 of impedance matching between the second resonator and the secondary circuit 52 shows the smallest matching loss less than 1 dB when the equivalent resistance of the secondary circuit is 100 Ω, and preferable impedance matching is achieved.

FIG. 26 is an explanatory diagram illustrating exemplary impedance values at respective portions in FIG. 25. FIG. 26 illustrates an output impedance characteristic 308 of the primary circuit, an input impedance characteristic 309 of the first resonator, an output impedance characteristic 310 of the second resonator, and an input impedance characteristic 311 of the secondary circuit respectively. The output impedance characteristic 308 of the primary circuit and the input impedance characteristic 309 of the first resonator mutually show equal impedance values. The output impedance characteristic 310 of the second resonator and the input impedance characteristic 311 of the secondary circuit show at least partly equal impedance values (in this case, when the equivalent resistance of the secondary circuit is 100 Ω). By this, preferable impedance matching can be achieved between the first resonator and the primary circuit and between the second resonator and the secondary circuit.

Meanwhile, in FIG. 1, the exemplary configuration in which the parallel resonance capacitance (36, 39) are connected to the first coil 37 and the second coil 38 in parallel, respectively, but the same effect can be also achieved in a configuration in which a series resonance capacitance is connected to each of the first coil 37 and the second coil 38 in series.

<Structure of Resonator (Coil)>

FIGS. 2(a) to 2(e) are diagrams illustrating exemplary structures of first and second coils inside the first and second resonators the power transmission device of FIG. 1. FIGS. 2(a) and 2(b) are plan views respectively illustrating exemplary conductor patterns of first and second conductor layers constituting the first coil 37, FIGS. 2(c) and 2(d) are plan views respectively illustrating exemplary conductor patterns of third and fourth conductor layers constituting the second coil 38. FIG. 2(e) is a cross-sectional view illustrating an exemplary structure between surfaces 100a and 100b in FIGS. 2(a) to 2(d).

In FIG. 2(a), a foil conductor coil 7 is formed of spiral-form conductor pattern in the first conductor layer of a dielectric substrate 8. The foil conductor coil 7 has one end provided with an input terminal 6 and the other end provided with a through via hole 4 used to electrically connect a foil conductor coil of the first conductor layer to that of the second conductor layer. Further, a through via hole 5 used to electrically connect a foil conductor coil of the third conductor layer to that of the fourth conductor layer is disposed in the first conductor layer in an isolated criteria so as to keep predetermined dielectric withstand voltage with the foil conductor coil 7.

In FIG. 2(b) a foil conductor coil 12 is formed of the spiral form conductor pattern in the second conductor layer of the dielectric substrate 8. The foil conductor coil 12 has one end provided with an input terminal 9 and the other end provided with the through via hole 4. The foil conductor coil 12 is connected to the foil conductor coil 7 of the first conductor layer via the through via hole 4. Further, the through via hole 5 as in the first conductor layer is disposed in the second conductor layer in an isolated criteria so as to keep predetermined dielectric withstand voltage with the foil conductor coil 12.

In FIG. 2(c), a foil conductor coil 14 is formed of the spiral-form conductor pattern in the third conductor layer of the dielectric substrate 8. The foil conductor coil 14 has one end provided with an output terminal 16 and the other end provided with the through via hole 5. Further, the through via hole 4 is disposed in the third conductor layer in an isolated criteria so as to keep predetermined dielectric withstand voltage with the foil conductor coil 14. In FIG. 2(d), a foil conductor coil 21 is formed of the spiral-form conductor pattern. in the fourth conductor layer of the dielectric substrate 8. The foil conductor coil 21 has one end provided with an output terminal 23 and the other end provided with the through via hole 5. Further, the through via hole 4 is disposed in the fourth conductor layer in an isolated criteria so as to keep predetermined dielectric withstand voltage with the foil conductor coil 21.

In FIG. 2(e), the dielectric substrate 8 includes first to fourth conductor layers (7, 12, 14, 21) arranged in order of a stacking direction, and a plurality of dielectric layers 10 respectively disposed between the first and fourth conductor layers. As described above, the first coil 37 includes the foil conductor coils 7, 12 of the first and second conductor layers, and the second coil 38 includes the foil conductor coils 14, 21 of the third and fourth conductor layers. The dielectric layer (insulation layer) between. the foil conductor coils 12 and 14 has a thickness to secure the predetermined dielectric withstand voltage.

In FIGS. 2(a) to 2(d), an outer diameter of the foil conductor coil (conductor pattern) 7 of the first conductor layer and the foil conductor coil (conductor pattern) 12 of the second conductor layer is indicated as W1, and an inner diameter thereof is indicated as W2. Further, an outer diameter of the foil conductor coil (conductor pattern) 14 of the third conductor layer and the foil conductor coil (conductor pattern) 21 of the fourth conductor layer is indicated as W3, and an inner diameter thereof is indicated as W4. In a preferable embodiment, the outer diameters W1, W3 are formed to have a maximum diameter in the dielectric substrate 8 that has a restricted size due to miniaturization., thereby improving the coupling coefficient between the first coil 37 and the second coil 38 and achieving improvement of transmission efficiency.

Further, the inner diameter W2, W4 are formed to have a minimum diameter enough to keep the predetermined dielectric withstand voltage between the through via holes 4 and 5, thereby increasing the number of turns and a line width of each of the coils, improving a coefficient Q, and improving the transmission efficiency. Moreover, the first coil 37 is formed of the conductor pattern in which the number of turns is fewer and the line width is larger compared to the second coil 38, thereby reducing impedance of the first coil 37 relatively smaller than impedance of the second coil 38. As a result, impedance matching as described in FIGS. 23 to 26 is achieved, and transmission efficiency can be improved. In other words, compared to the secondary circuit 52, the first resonator performs impedance matching with the primary circuit 51 having lower impedance, and the second resonator performs impedance matching with the secondary circuit 52.

<Application Examples of Power Transmission Device>

FIG. 3 is a diagram schematically illustrating an exemplary configuration of a power switching element drive system in which the power transmission device in FIG. 1 is applied, The power switching element drive system illustrated in FIG. 2 includes a driver circuit 48, a power semiconductor element 50, and a controller 49 in addition to the exemplary configuration illustrated in FIG. 1. The controller 49 transmits a control signal to the driver circuit 48 via a control signal line 53, and controls the driver circuit 48 by receiving a feedback signal via a feedback signal line 54. The power semiconductor element 50 is, for example, a switching element such as an insulated gate bipolar transistor (IGET) used in a high-voltage inverter and the like.

Power is supplied to the driver circuit 48 from the output terminals (120 to 122) of the secondary circuit 52, and the driver circuit 48 controls the power semiconductor element 50 in accordance with a control signal from the controller 49. Although not particularly limited, voltage from +several volts to +several tens volts is generated at the output terminal 120, and voltage from −several volts to −several tens volts is generated at the output terminal 122, basing voltage at the output terminal 121 in FIG. 1, The driver circuit 48 controls on/off of the power semiconductor element 50 by using the positive and negative voltage, Meanwhile, although not particularly limited, voltage of several tens volts is supplied to the input end of the first resonator.

For example, power is transmitted by using a coreless resonator as illustrated in FIGS. 2(a) to 2(e) in the above-described system, thereby achieving more size reduction (particularly height reduction) and more cost saving for the resonator, compared to the case of using a discrete transformer component. Further, power transmission efficiency can be improved by the above-described impedance matching. As a result, power consumption and the like in the system can be reduced.

<Main Effects of Present Embodiment>

As described above, the power transmission device according to the first embodiment has the configuration in which the multilayer foil conductor coils are formed as internal layers of the dielectric substrate, and asymmetric impedance is held while securing the dielectric withstand voltage required to prevent surge voltage generated at an power apparatus from sneaking into the first coil and the second coil, and impedance matching is performed between the first coil and the primary circuit and between the second coil and the secondary circuit respectively. With this configuration, there are representative effects in which size reduction of the power transmission device and higher power transmission efficiency can be achieved.

FIG. 4 is an explanatory diagram illustrating an exemplary effect in the power transmission device in FIG. 1. In FIG. 4, a horizontal axis and a vertical axis represent normalized input impedance of the secondary circuit 52 and normalized transmission efficiency, respectively. Here, the input impedance of the first resonator is fixed at 4 Ω, and the output impedance of the second resonator are 4 Ω, 8 Ω, and 17 Ω, and 28 Ω, and respective characteristic curves S100, S101, S102, S103 are plotted. The larger the output impedance of the second resonator (specifically, second coil 38) becomes in accordance with increase of the normalized input impedance of the secondary circuit, the more improved transmission efficiency is. By this, it is clear that differentiating the input impedance of the first resonator (first coil 37) frock he output impedance of the second resonator (second coil 38) is effective.

Further, another effect provided by the circuit configuration of the power transmission device in FIG. 1 is that various output voltage can be generated with high accuracy. For example, as a method of extracting various output voltage from a secondary side of a transformer, there may be a method in which a center tap is disposed in the middle of the secondary side coil and the voltage of the secondary side coil is divided at a predetermined ratio in accordance with the disposed position of the center tap. This method is an effective method particularly in the case of using a transformer including a core. In the case of using the careless resonator in which leakage of magnetic flux maybe caused at various places like the present embodiment, the voltage dividing ratio can be hardly set with high accuracy.

Therefore, in the exemplary configuration in FIG. 1, output from the secondary side is received in the diode bridge circuit 43 via the capacitance 41, 42, thereby performing the DC component separation on the way with the diode bridge circuit 40. Further, a ratio of input voltage to the diode bridge circuits 43 and 40 is adjusted by adjusting the capacitance value of the capacitance 41, 42. For example, in the case of reducing she capacitance values of the capacitance 41, 42, the input voltage to the diode bridge circuit 43 becomes smaller compared to the diode bridge circuit 40 due to the impedance component thereof, and the output voltage generated between the output terminals 121 and 122 becomes small.

### Second Embodiment

<Configuration of Main Portion of Power Transmission Device (Various Modified Examples)>

FIG. 5 is a circuit diagram schematically illustrating an exemplary configuration in which the number of output terminals is reduced in a main portion. of a power transmission device according to a second embodiment of the present invention. Compared with an exemplary configuration illustrated in FIG. 1, the power transmission device illustrated in FIG. 5 has a configuration in which a rectifying circuit portion including a diode bridge circuit 43 is eliminated from a secondary circuit 156. More specifically, in the power transmission device of FIG. 5, predetermined output voltage is generated between output terminals 120 and 121 by the rectifying circuit portion having a one-stage configuration including a diode bridge circuit 40, a smoothing capacitance 44, and a Zener diode 46. With this configuration, for example, power can be supplied to a driver circuit and the like with a single power source.

FIG. 6 is a circuit diagram schematically illustrating an exemplary configuration in which the number of output terminals is increased in the main portion of the power transmission device according to the second embodiment of the present invention. Compared to the exemplary configuration illustrated in FIG. 1, the power transmission device illustrated in FIG. 6 has a configuration in which a rectifying circuit portion including a diode bridge circuit 241 is further added in the secondary circuit 157. More specifically, the power transmission device in FIG. 6 includes a third rectifying circuit portion including capacitance 242, 243, diode bridge circuit 241 formed of rectifier diodes D9 to D12, smoothing capacitance 145, and a Zener diode 147 in addition to the rectifying circuit portion having a two-stage configuration illustrated in FIG. 1. The capacitance 242, 243 has a function of DC cutting and a function of adjusting output voltage as in tie case of a first embodiment.

By this third rectifying circuit portion, the predetermined output voltage is generated between output terminals 122 and 123 in addition to between the output terminals 120 and 121 and between the output terminals 121 and 122. With this configuration, power can be supplied to a circuit actuated by three or more power sources. Meanwhile, this configuration can be applied to a circuit actuated by four or more power sources by increasing the number of stages of the rectifying circuit portion in the same mariner.

FIG. 7 is a circuit diagram schematically illustrating an exemplary configuration in which a regulator is used in the main portion of the power transmission device according to the second embodiment of the present invention. Compared to the exemplary configuration in FIG. 5, the power transmission device illustrated in FIG. 7 has a configuration in which the Zener diode 46 is eliminated from the rectifying circuit portion having the one-stage configuration, and two regulators 62, 63 are connected in parallel to both ends of the smoothing capacitance 44. Output of the regulators 62, 63 is connected in series, and the regulator 62 generates predetermined output. voltage between the output terminals 120 and 121 while the regulator 63 generates the predetermined output voltage between the output terminals 121 and 122. The regulators 62, 63 supply power to, for example, the driver circuit 48 illustrated in FIG. 3.

For the regulators 62, 63, a linear regulator or a DC/DC converter can be applied, particularly, in the case where voltage at both ends of the smoothing capacitance 44 is sufficiently large, the linear regulator having a simple circuit can be applied. The regulators 62, 63 are connected to both ends of the smoothing capacitance 44 in parallel, and convert input impedance of the driver circuit 48 to smaller impedance. Therefore, even in the case where output impedance of second resonators (38, 39) is small, impedance matching can be easily performed.

By using the regulators 62, 63, the respective output voltage between the output terminals 120 and 121 and between the output terminals 121 and 122 can be adjusted with accuracy higher than the case in FIG. 1. Further, since the input impedance of the driver circuit 48 is converted to the small impedance, impedance matching can be easily performed even in the second resonator having small output impedance (specifically, second coil 38). The total number of rectifier diodes used in the diode bridge circuit is reduced as well

FIG. 8 is a circuit diagram schematically illustrating an exemplary configuration in which a DC/DC converter is used in the main portion of the power transmission device according to the second embodiment of the present invention. Compared to the exemplary configuration in FIG. 5, the power transmission device illustrated in FIG. 8 has a configuration in which the Zener diode 46 is eliminated from the rectifying circuit portion having one-stage configuration, a DC/DC converter 64 is connected. to both ends of the smoothing capacitance 44, and further a DC/DC converter 65 is connected to output thereof. Output of the DC/DC converter 64, 65 is connected in series, and the DC/DC converter 64 generates the predetermined output voltage between the output terminals 120 and 121 while the DC/DC converter 65 generates the predetermined output voltage between the output terminals 121 and 122.

For the DC/DC converter, a step-up type that increases voltage or a step-down type that decreases voltage can be applied. The output of the DC/DC converter 64 is connected in parallel to the DC/DC converter 65 and the driver circuit 48 illustrated in FIG. 3, for example. The DC/DC converter 65 outputs the received voltage to the driver circuit 48 after shifting the voltage level.

By using the DC/DC converters 64, 65, even in the case where output voltage of the second resonators (38, 39) is smaller than an operational input rating of the DC/DC converter 65, the output voltage can be made to conform to the operational input rating of the DC/DC converter 65 by performing boosting with the DC/DC converter 64. Further, by using the DC/DC converters 64, 65, the respective output voltage between the output terminals 120 and 121 and between the output terminals 121 and 122 is easily adjusted with accuracy higher than in the case of FIG. 1.

### Third Embodiment

<Structure of Resonator (Coil) (Modified Examples)>

FIGS. 9(a) to 9(d) are diagrams illustrating exemplary structures in which inner diameters of first and second coils inside first and second resonators are different in a power transmission device according to a third embodiment of the present invention, and are modified examples of the first and second coils illustrated in FIGS. 2(a) to 2(d). FIGS. 9(a) and 9(b) are plan views illustrating exemplary conductor patterns of first and second conductor layers constituting the first coil 37, respectively. FIGS. 9(c) and 9(d) are plan views illustrating exemplary conductor patterns of third and fourth conductor layers constituting the second coil 38, respectively.

In FIGS. 9(a) and 9(b) a foil, conductor coil 80 formed in the first conductor layer of a dielectric substrate 8 and a foil conductor coil 81 formed in the second conductor layer and connected to the foil conductor coil 80 via, a through via hole 4 have an outer shape W1 and an inner diameter 102. In FIGS. 9(c) and 9(d), a foil conductor coil 82 formed in the third conductor layer of a dielectric substrate 8 and a foil conductor coil 83 formed in the fourth conductor layer and connected to the foil conductor coil 82 via a through via hole 5 have an outer shape W1 and an inner diameter W4.

More specifically, the outer shape W1 of the first coil 37 illustrated in FIGS. 9(a) and 9(b) is equal to the outer shape W1 of the second coil 38 illustrated in FIGS. 9(c) and 9(d) The inner diameter W2 of the first coil 37 is formed larger than the inner diameter W4 of the second coil 38. With this structure, even in the case where a foil conductor coil (conductor pattern) of the first coil 37 has a line width same as a foil conductor coil (conductor pattern) of the second coil 38, impedance of the first coil 37 becomes smaller than impedance of the second coil 38. As a result, input impedance of a first resonator including the first coil 37 becomes smaller than output impedance of a second resonator including the second coil 38. Therefore, impedance matching can be achieved between a primary circuit 51/a secondary circuit 52 and the respective resonators in FIG. 1, thereby improving transmission efficiency.

FIGS. 10(a) to 10(d) are diagrams illustrating exemplary structures in which outer diameters of the first and second coils in the first and second resonators are different in the power transmission, device according to the third embodiment of the present invention. FIGS. 10(a) and 10(b) are plan views illustrating exemplary conductor patterns of the first and second conductor layers constituting the first coil 37, respectively, FIGS. 10(c) and 10(d) are plan views illustrating exemplary conductor patterns of the third and fourth conductor layers constituting the second coil 38, respectively.

In FIGS. 10(a) and 10(b), a foil conductor coil 84 formed in the first conductor layer of the dielectric substrate 8 and a foil conductor coil 85 formed in the second conductor layer and connected to the foil conductor coil 84 via the through via hole 4 have an outer shape W1 and an inner diameter W2. In FIGS. 10(c) and 10(d), a foil conductor coil 86 formed in the third conductor layer of the dielectric substrate 8 and a foil conductor coil 87 formed in the fourth conductor layer and connected to the foil conductor coil 86 via the through via hole 5 have an outer shape W3 and an inner diameter W2.

More specifically, the inner diameter W2 of the first coil 37 illustrated in FIGS. 10(a) and 10(b) is equal to the inner diameter W2 of the second coil 38 illustrated in FIGS. 10(c) and 10(d). The outer shape W1 of the first coil 37 is formed smaller than the outer shape W3 of the second coil 38. With this structure, even in the case where a foil conductor coil (conductor pattern) of the first coil 37 has a line width same as a foil conductor coil (conductor pattern) of the second coil 38, impedance of the first coil 37 becomes smaller than impedance of the second coil 38. As a result, input impedance of the first resonator including the first coil 37 becomes smaller than output impedance of the second resonator including the second coil 38. Therefore, impedance matching can be achieved between the primary circuit 51/secondary circuit 52 and each of the resonators in FIG. 1 respectively, thereby improving transmission efficiency.

FIGS. 11(a) to 11(d) are diagrams illustrating exemplary structures in which divided coils are applied to the first and second coils inside the first and second resonators in the power transmission device according to the third embodiment of the present invention. FIGS. 11(a) and 11(b) are plan views illustrating exemplary conductor patterns of the first and second conductor layers constituting the first coil 37, respectively. FIGS. 11(c) and 11(d) are plan views illustrating exemplary conductor patterns of the third and fourth conductor layers constituting the second coil 38, respectively.

In FIGS. 11(a) and 11(b), a foil conductor coil 88 is formed in the first conductor layer of the dielectric substrate 8, and a foil conductor coil 89 connected to the foil conductor coil 88 via a through via hole 4a is formed in the second conductor layer. Further, through via holes 5a, 5b used to electrically connect the foil conductor coil of the third conductor layer to that of the fourth conductor layers are disposed in the first and second conductor layers.

On the other hand, in FIGS. 11(c) and 11(d), two foil conductor coils 90, 91 are formed in an aligned manner in the third conductor layer of the dielectric substrate 8. The foil conductor coil 90 has one end provided with an output terminal 16a and the other end provided with the through via hole 5a described above. The foil conductor coil 91 has one end provided with an output terminal 16b and the other end provided with the through via hole 5b described above. In the same manner, two foil conductor coils 92, 93 are formed in art aligned manner in the fourth conductor layer of the dielectric substrate 8. The foil conductor coil 92 has one end provided with an output terminal 23a and the other end connected to the foil conductor coil 90 via the through via hole 5a. The foil conductor coil 93 has one end provided with an output terminal 23b and the other end connected to the foil conductor coil 91 via the through via hole 5b. Further, the above-described. through via hole 4a is disposed in the third and fourth. conductor layers.

Thus, in the exemplary structure of FIGS. 11(a) to 11(d) the second coil 38 is formed of two divided coils (coil formed of 90, 92 and coil formed of 91, 93). Therefore, output power of the first coil 37 can be transmitted in a manner distributed to the two coils. In this case, although not illustrated, power from the output terminals 16a, 23a and power from the output terminals 16b, 23b may be respectively and separately rectified at a diode bridge circuit without providing capacitance 41, 42 of FIG. 1, for example. Compared to the exemplary structure in FIG. 2 and the like, the exemplary structure in FIG. 11 has a merit in which the capacitance 41, 42 can be eliminated, but there may be a case where magnetic flux leakage is increased due to divided structure of the second coil 38, and also there may be a case where impedance matching becomes more complex. In this point of view, using a structure combining FIG. 1 with FIG. 2 and the like is more advantageous.

FIGS. 12(a) to 12(d) are diagrams illustrating exemplary structures in which a center tap is applied to the first and second coils inside the first and second resonators in the power transmission device according to the third embodiment of the present invention. FIGS. 12(a) and 12(b) are plan views illustrating exemplary conductor patterns of the first and second conductor layers constituting the first coil 37, respectively. FIGS. 12(c) and 12(d) are plan views illustrating exemplary conductor patterns of the third and fourth conductor layers constituting the second coil 38, respectively.

In FIGS. 12(a) and 12(b), a foil conductor coil 112 is formed in the first conductor layer of the dielectric substrate 8, and a foil conductor coil 113 connected to the foil conductor coil 112 via a through via hole 4f is formed on the second conductor layer. Further, a through via hole 5f used to electrically connect the foil conductor coil of the third conductor layer to that of the fourth conductor layer and a through via hole 5g corresponding to the center tap of the second coil 38 are disposed in the first and second conductor lavers.

In FIGS. 12(c) and 12(d), a foil conductor coil 110 is formed in the third conductor layer of the dielectric substrate 8, and a foil conductor coil 111 connected to the foil conductor coil 110 via the above-described through via hole 5f is formed. in the fourth conductor laver. Further, here in the third conductor layer, the above-described through via hole 5g is disposed. in the middle of a wound wire of the foil conductor coil 110 (in other words, center tap of the second coil 38) In the fourth conductor layer, a conductor pattern in which an output terminal 901 and the through via hole 5g are disposed at both ends respectively, and voltage extracted from the center tap of the second coil 38 is output to the output terminals 901.

With this structure, the second coil 38 can output voltage to a node between the output terminal 16 and the output terminal 901 and a node between the output terminal 901 and the output terminal 23 respectively. The respective voltage is separately rectified at the diode bridge circuit in the same manner as in the case of FIG. 11. As described in the first embodiment, the exemplary structure in FIG. 12 corresponds to a method of using the center tap, and in this case, there may be a case where a ratio between the respective output voltage cannot be set with high accuracy. In this point of view, using a structure combining FIG. 1 with FIG. 2 and the like is more advantageous.

FIGS. 13(a) and 13(b) are diagrams illustrating exemplary structures in which a line width of the first coil inside the first resonator is devised in the power transmission device according to the third embodiment of the present invention. FIGS. 13 (a) and 13 (b) are plan views illustrating exemplary conductor patterns of the first and second conductor layers constituting the first coil 37, respectively.

In FIGS. 13(a) and 13(b), a foil conductor coil 94 is formed in the first conductor layer of the dielectric substrate 8, and a foil conductor coil 95 connected to the foil conductor coil 94 via a through via hole 4 is formed on the second conductor layer. In the foil conductor coils 94, 95 each formed of a spiral-form conductor pattern, a line width in a section differs from a line width in other sections. More specifically, a line width W8 in the vicinity of a middle section of the conductor pattern, where wiring density is particularly high, is thicker than a line width W9 in the vicinity of an edge section where wiring density is lower than the middle section.

In the section having high wiring density, temperature density is higher compared to the section having low wiring density. Therefore, a resistance value of the coil may be increased. Therefore, by forming the line width thick in the section having high wiring density as illustrated in FIGS. 13(a) and 13(b), the temperature can be suppressed from being increased. More specifically, normally, size reduction of the coil, can be achieved by increasing the wiring density, but size reduction of the coil and suppression of heat generation can be effectively achieved by suppressing the temperature increase caused by a side effect thereof in the method illustrated in FIGS. 13(a) and 13(b). Here, note that the same effect can be achieved by forming the second coil 38 in the same manner although the description has been given by exemplifying the first coil 37.

FIGS. 14(a) and 14(b) are diagrams illustrating exemplary structures in which arrangement of a through via hole of the first coil inside the first resonator is devised in the power transmission device according to the third embodiment of the present invention.

FIGS. 14(a) and 14(b) are plan views illustrating exemplary conductor patterns of the first and second conductor layers constituting the first coil 37, respectively.

In FIGS. 14(a) and 14(b), a foil conductor coil 96 is formed in the first conductor layer of the dielectric substrate 8, and a foil conductor coil 97 connected to the foil conductor coil 96 via a through via hole 4c is formed in the second conductor layer. Different from FIGS. 9(a) and 9(b) and the like, each of the foil conductor coils 96, 97 is formed of a conductor pattern in, which a wire is spirally wound in a rectangular shape and a tip of the wire extends in a diagonal direction. of the rectangular shape. The through via hole 4c is disposed at the wire tip extending in the diagonal direction.

Further, although not illustrated, the second coil 38 is formed. in the same manner in the third and fourth conductor layers. As a result in the first and second conductor layers, the through via hole 5c used to electrically connect the foil conductor coil of the third conductor layer to that of the fourth conductor layer is disposed in the above-described diagonal direction as illustrated in FIGS. 14(a) and 14(b). Since the through via hole 4c and the through via hole 5c are disposed utilizing the diagonal direction, a distance therebetween can be easily secured. and an insulating distance between the first coil 37 and the second coil 38 can be easily secured even in the case of reducing the coil size.

FIGS. 15(a) and 15(b) are diagrams illustrating exemplary structures in which a corner portion. of the first coil inside the first resonator is devised in the power transmission device according to the third embodiment of the present invention. FIGS. 15(a) and 15(b) are plan views illustrating exemplary conductor patterns of the first and second conductor layers constituting the first coil 37, respectively.

In FIGS. 15(a) and 15(b), a foil conductor coil 98 is formed in the first conductor layer of the dielectric substrate 8, and a foil conductor coil. 99 connected to the foil conductor coil 98 via a through via hole 4 is formed in the second conductor layer. Different from FIGS. 9(a) and 9(b) and the like, each of the foil conductor coils 98, 99 is formed of a conductor pattern in which a corner portion of a wound wire is formed in a curve shape. The sharper an angle of the corner portion of the wound wire is, the more concentrated electric field is. Therefore, unnecessary radiation may be caused. Considering this, such unnecessary radiation can be reduced by forming the corner portion in the curved shape. Here, note that the same effect can be achieved by forming the second coil 38 in the same manner although the description has been given by exemplifying the first coil 37.

FIGS. 16(a) and 16(b) are diagrams illustrating exemplary structures in which a corner portion of the first coil inside the first resonator is devised in the power transmission device according to the third embodiment of the present invention. FIGS. 16(a) and 16(b) are plan views illustrating exemplary conductor patterns of the first and second conductor layers constituting the first. coil 37, respectively.

In FIGS. 16(a) and 16(b), a foil conductor coil 100 is formed in the first conductor layer of the dielectric substrate 8, and a foil conductor coil 101 connected to the foil conductor coil 100 via a through via hole 4 is formed in the second conductor layer. Different from FIGS. 9(a) and 9(b) and the like, each of the foil conductor coils 100, 101 is formed of a conductor pattern in which a corner portion of a wound wire is formed in a polygonal shape. For example, when it seems difficult to form the conductor pattern to have the curved shape as illustrated in FIGS. 15(a) and 15(b), unnecessary radiation can be reduced by using the conductor pattern. as illustrated in FIGS. 16(a) and 16(b). Here, note that the same effect can be achieved by forming the second coil 38 in the same manner although the description has been given by exemplifying the first coil 37.

FIGS. 1 (a) and 17(b) are diagrams illustrating exemplary structures in which winding in the first coil inside the first resonator is devised in the power transmission device according to the third embodiment of the present invention. FIGS. 18(a) and 18(b) are diagrams illustrating exemplary structures of the second coil inside the second resonators in the power transmission device in FIGS. 17(a) and 17 (b). FIGS. 17(a) and 17(b) are plan views illustrating exemplary conductor patterns of the first and second conductor layers constituting the first coil 37, respectively. FIGS. 18(a) and 18(b) are plan views illustrating exemplary conductor patterns of the third and fourth conductor layers constituting the second coil 38, respectively.

In FIG. 17(a), two foil conductor coils 102, 103 are formed adjacent to each other in the first conductor layer of the dielectric substrate 8. The foil conductor coil 102 has one end provided with an input terminal 6a and the other end provided with a through via hole 4d. The foil conductor coil 103 has one end provided with an input terminal 6h and the other end provided with a through via hole 4e.

In FIG. 17(b), two conductor patterns each having a spiral form are formed adjacent to each other in the second conductor layer of the dielectric substrate 8, and one foil conductor coil 104 is formed by connecting these two conductor patterns in series. In other words, the foil conductor coil 104 has the conductor pattern wound in a figure “8”. In one of the two conductor patterns, the wire is wound clockwise, and in the other conductor pattern, the wire is wound anti-clockwise. With this structure, magnetic flux directions generated from the respective two conductor patterns are substantially opposite directions. The foil conductor coil 104 has one end connected to the foil conductor coil 102 via the above-described through via hole 4d and the other end connected to the foil conductor coil 103 via the above-described through via hole 4e.

In the same manner, in FIG. 18(b), two foil conductor coils 106 and 107 are formed adjacent to each other in the fourth conductor layer of the dielectric substrate 8. The foil conductor coil 106 has one end provided with an input terminal 23c and the other end provided with a through via hole 5d. The foil conductor coil 107 has one end provided with an input terminal 23d and the other end provided with a through via hole 5e.

In FIG. 18 (a), two conductor patterns each having a spiral form are formed adjacent to each other in the third conductor layer of the dielectric substrate 8, and one foil conductor coil 105 is formed by connecting the two conductor patterns in series. In other words, the foil conductor coil 105 has the conductor pattern wound in a figure “8”. Magnetic flux directions generated from the respective two conductor patterns are substantially opposite directions. The foil conductor coil 105 has one end connected to the foil conductor coil 106 via the above-described through via hole 5d and the other end connected to the foil conductor coil 107 via the above-described through via hole 5e.

Thus, the magnetic fluxes of the adjacent conductor patterns are mutually coupled by using the coil in which a plurality of spiral-form conductor patterns is formed adjacent. to each other inside the same conductor layer and the magnetic flux directions of the adjacent conductor patterns are substantially opposite directions. Therefore, an effect of improving transmission efficiency can be achieved.

### Fourth Embodiment

<Configuration of Main Portion of Power Transmission Device (Various Modified Examples)>

FIG. 19 is a circuit diagram schematically illustrating an exemplary configuration in which an electronic variable capacitance is applied to the main portion in a power transmission device according to a fourth embodiment of the present invention. Compared to an exemplary configuration illustrated in FIG. 1, the power transmission device illustrated in FIG. 19 has a configuration in which a voltage wave detector 67, a control logic circuit 68, and an electronic variable capacitance 66 are added to the inside of a secondary circuit 152. The electronic variable capacitance 66 is provided in place of capacitance 39 inside the second resonator in FIG. 1.

In the secondary circuit 152, the voltage wave detector 67 detects output voltage between output. terminals 120 and 121 and output voltage between output terminals 121 and 122 respectively, and outputs output voltage levels thereof to the control logic circuit 68a. The control logic circuit (second control logic circuit) 68a determines the output voltage level from the voltage wave detector 67 on basis of a preset input voltage rating of a driver circuit 48 in FIG. 3, and switches a capacitance value of the electronic variable capacitance 66 such that the output voltage level conforms to the input voltage rating. In other words, the control logic circuit 68a controls the capacitance value of the electronic variable capacitance 66 in accordance with change of power supplied to the driver circuit 48, and shifts a resonance frequency.

The driver circuit 48 and a power semiconductor element 50, which are connected to the secondary circuit 152, cause load fluctuation due to change of environment such as temperature, secular change, and the like. For example, in the case where power supplied to the driver circuit 48 is excessive, transmission power can be reduced by separating the resonance frequency from an AC frequency of transmission power by switching the capacitance value. In contrast, in the case where power supplied to the driver circuit 48 is short because the resonance frequency is separated from the AC frequency due to secular change and the like, transmission power can be increased by approximating the resonance frequency to the AC frequency by switching the capacitance value. Although not particularly limited, the electronic variable capacitance 66 is formed of a circuit in which plural capacitance having different capacitance values is connected in parallel so as to control connection of each capacitance to the parallel-connected node by an electronic switch.

FIG. 20 is a circuit diagram schematically illustrating an exemplary configuration in which an electronic variable inductor is applied to the main portion in the power transmission device according to the fourth embodiment of the present invention. Compared to the exemplary configuration illustrated in FIG. 1, the power transmission device illustrated in FIG. 20 has a configuration in which the voltage wave detector 67, a control logic circuit 68b, and electronic variable inductors 69, 70 are added to the inside of a secondary circuit 153. The electronic switch inductor 69 is connected, in series, to one of two wires between output ends of the second resonators (38, 39) and a diode bridge circuit 40 (and 43), and the electronic variable inductor 70 is connected, in series, to the other one of the two wires in an interposed manner.

In the secondary circuit 153, the voltage wave detector 67 detects the output voltage between the output term ins 120 and 121 and the output voltage between the output terminals 121 and 122 respectively, and outputs output voltage levels thereof to the control logic circuit 68b. The control logic circuit (first control logic circuit) 68b determines the output voltage level from. the voltage wave detector 67 on basis of the preset input voltage rating of the driver circuit 48 in FIG. 3, and controls an inductance value of the electronic variable inductor 69 such that the output voltage level conforms to the input voltage rating. More specifically, the control logic circuit 68b controls impedance values of the electronic variable inductors 69, 70 to be examples of an impedance variable circuit in accordance with change of power supplied to the driver circuit 48.

For example, in the case where the supplied power is excessive, transmission power can be reduced by controlling, via the electronic variable inductors 69, 70, impedance matching between the second resonators (38, 39) and the secondary circuit 153 in a direction separating from a matched state. In contrast, in the case where the supplied power is short, transmission power can be increased by controlling, via the electronic variable inductors 69, 70, impedance matching between the second resonators (38, 39) and the secondary circuit 153 in a direction approximating to the matched state.

FIG. 21 is a circuit diagram schematically illustrating an exemplary configuration different from FIG. 20, in which the electronic variable inductor is applied to the main portion in the power transmission device according to the fourth embodiment of the present invention. Compared to the exemplary configuration illustrated in FIG. 1, the power transmission device illustrated in FIG. 21 has a configuration in which the voltage wave detector 67, a control logic circuit 68c, an insulation communication transmission circuit 73, a transmission coupler 74 are added to the inside of a secondary circuit 154, and a reception coupler 75, an insulation communication reception circuit 76, and electronic variable inductors 71, 72 are added to the inside of a primary circuit 160. The electronic variable inductor 71 is connected, in series, to one of two wires between input ends of the first resonators (36, 37) and an automatic voltage adjustment circuit 35, and the electronic variable inductor 72 is connected, in series, to the other one of the two wires in an interposed manner

In the secondary circuit 154, the voltage wave detector 67 detects output voltage between output terminals 120 and 121 and output voltage between output terminals 121 and 122 respectively, and outputs output voltage levels thereof to the control logic circuit 68c. The control logic circuit 68c determines the output voltage level from the voltage wave detector 67 on basis of the preset input voltage rating of the driver circuit 48 in FIG. 3, and generates a control signal in order to set inductor values for the electronic variable inductors 71, 72 such that the output voltage level conforms to the input voltage rating.

The control signal from the control logic circuit 68c is transmitted from the transmission coupler 74 via the insulation communication transmission circuit 73, and received in the insulation communication reception circuit 76 via the reception coupler 75. The insulation communication reception circuit 76 controls the inductor values of the electronic variable inductors 71, 72 by using the control signal. The insulation communication transmission circuit 73 and the insulation communication reception circuit. 76 are communication circuit directed to performing communication between the insulation communication transmission circuit 73 and the insulation communication reception circuit 76 while securing insulation. The transmission coupler 74 and the reception coupler 75 are formed so as to have dielectric withstand voltage larger than that between the first coil 37 and the second coil 38.

With this configuration, the inductance values of the electronic variable inductors 71, 72 are controlled in accordance with change of transmission power supplied to the driver circuit 48. For example, in the case where the supplied power is excessive, transmission power can be reduced by controlling, via the electronic variable inductors 71, 72, impedance matching between the first resonators (36, 37) and the primary circuit 160 in a direction separating from the matched state. In contrast, in the case where the supplied power is short, transmission power can be increased by controlling, via the electronic variable inductors 71, 72, impedance matching between the first resonators (36, 37) and the primary circuit 160 in a direction approximating to the matched state.

FIG. 22 is a circuit diagram schematically illustrating an exemplary configuration different from FIG. 19, in which the electronic variable capacitance is applied to the main portion in the power transmission device according to the fourth embodiment of the present invention. Compared to the exemplary configuration illustrated in FIG. 1, the power transmission device illustrated in FIG. 22 has a configuration in which the voltage wave detector 67, a control logic circuit 68d, the insulation communication transmission circuit 73, the transmission coupler 74 are added to the inside of a secondary circuit 155, and the reception coupler 75, the insulation communication reception circuit 76, and an electronic variable capacitance 77 are added to the inside of a primary circuit 161. The electronic variable capacitance 77 is connected to the input ends of the first resonators (36, 37).

In the secondary circuit 155, the voltage wave detector 67 detects output voltage between output terminals 120 and 121 and output voltage between output terminals 121 and 122 respectively, and outputs output voltage levels thereof to the control logic circuit 68d. The control logic circuit 68d determines the output voltage level from the voltage wave detector 67 on basis of the preset input voltage rating of the driver circuit 48 in FIG. 3, and generates a control signal in order to set a capacitance value of the electronic variable capacitance 77 such that the output voltage level conforms to the input voltage rating.

The control signal from the control logic circuit 68d is transmitted from the transmission coupler 74 via the insulation communication transmission circuit 73, and received in the insulation communication reception circuit 76 via the reception coupler 75 as in the case of FIG. 21. The insulation communication reception circuit 76 controls the capacitance value of the electronic variable capacitance 77 by using the control signal. In other words, the control logic circuit 68d controls the capacitance value of the electronic variable capacitance 77 in accordance with change of power supplied to the driver circuit 48, and shifts a resonance frequency. For example, in the case where power supplied to the driver circuit 48 is excessive, transmission power can be reduced by separating the resonance frequency from the AC frequency of transmission power by switching the capacitance value. In contrast, in the case where power supplied to the driver circuit 48 is short, transmission power can be increased by approximating the resonance frequency to the AC frequency by switching the capacitance value.

As described above, the power transmission device according to the fourth embodiment has the configuration in which the resonance frequency is changed or the state of impedance matching is changed by adjusting the variable capacitance or the variable inductor in accordance with change of transmission power supplied to a load (such as the driver circuit). With this configuration, power supply to a load can be controlled in accordance with the load fluctuation due to change of environment, such as temperature, secular change, and the like.

While the present invention made by the inventor has been described above based on the embodiments, the present invention is not limited to the above-described embodiment and various kinds of modification can be made in a range without departing from the grist of the present invention. For example, the above-described embodiments are described in detail to clearly explain the present invention in an easy-to-understand manner, and are not necessarily limited to that including all of the configurations that have been described. Additionally, a part of a configuration of a certain embodiment can be substituted by a configuration of a different embodiment, and a configuration of a different embodiment can be added to a configuration of a certain embodiment. Further, addition, deletion, and substitution of other configurations can be made to a part of the configurations of the respective embodiments.

For example, each of the first and second coils is formed by using two conductor layers here, but not limited thereto, one or both of the first and second coils may be formed of three or more conductor layers, or may be formed of one conductor layer depending on circumstances.

### REFERENCE SIGNS LIST

4, 4a, 4c to 4f, 5, 5a to 5g Through via hole
6, 6a, 6b, 9 Input terminal
7, 12, 14, 21, 80 to 107, 110 to 113 Foil conductor coil
8 Dielectric substrate
10 Dielectric layer
16, 16a, 16b, 23, 23a to 23d, 901 Output terminal
34 DC power circuit
35 Automatic voltage adjustment circuit
36, 39 Parallel resonance capacitance
37 First coil
38 Second coil
40, 43, 241 Diode bridge circuit
41, 42, 242, 243 Capacitance
44, 45, 145 Smoothing capacitance
46, 47, 147 Zener diode
48 Driver circuit
49 Controller
50 Power semiconductor element
51, 160, 161 Primary circuit
52, 150 to 157 Secondary circuit
53 Control signal line
54 Feedback signal line
62, 63 Regulator
64, 65 DC/DC converter
66, 77 Electronic variable capacitance
67 Voltage wave detector
68a to 68d Control logic circuit
69 to 72 Electronic variable inductor
73 Insulation communication transmission circuit.
74 Transmission coupler
75 Reception coupler
76 Insulation communication reception circuit
120, 121, 122, 123 Output terminal
300 Characteristic of impedance matching between first resonator and primary circuit
301 Characteristic of impedance matching between second resonator and secondary circuit
302 Output impedance characteristic of primary circuit
303 Input impedance characteristic of first resonator
304 Output impedance characteristic of second resonator
305 Input impedance characteristic of secondary circuit
306 Characteristic of impedance matching between first resonator and primary circuit
307 Characteristic of impedance matching between second resonator and secondary circuit
308 Output impedance characteristic of primary circuit
309 Input impedance characteristic of first resonator
310 Output impedance characteristic of second resonator
311 Input impedance characteristic of secondary circuit
D1 to D12 Rectifier diode

1. A power transmission device, comprising:
a first resonator;
a second resonator coupled to the first resonator via electromagnetic waves;
a primary circuit connected to an input end of The first resonator and configured to supply power to the first resonator; and
a secondary circuit connected to an output end of the second resonator and configured to be supplied with power from the second resonator,
wherein the first resonator is insulated from the second resonator,
output impedance of the primary circuit is different from input impedance of the secondary circuit,
impedance matching is performed between the output impedance of the primary circuit and impedance in the case of viewing the first resonator side from the input end of the first resonator, and
impedance matching is performed between the input impedance of the secondary circuit and impedance in the case of viewing the second resonator side from the output end of the second resonator.

2. The power transmission device according to claim 1, wherein
the first resonator includes a first coil and first capacitance connected to the first coil in series or in. parallel,
the second resonator includes a second coil and second capacitance connected to the second coil in series or in parallel, and
each of the first coil and the second coil includes a spiral-form conductor pattern formed on a dielectric substrate.

3. The power transmission device, according to claim 2, wherein
the dielectric substrate includes
a plurality of conductor layers arranged in order of a stacking direction; and
a plurality of dielectric layers respectively disposed between the plurality of conductor layers,
at least one of the first coil and the second coil includes two or more conductor patterns each formed inside two or more conductor layers out of the plurality of conductor layers, and
the two or more conductor patterns are connected via a through via hole disposed inside the dielectric layer.

4. The power transmission device according to claim 2, wherein
the conductor pattern of the first coil has a line width in accordance with output impedance of the primary circuit, and the conductor pattern of the second coil has a line width different from the first coil in accordance with input impedance of the secondary circuit.

5. The power transmission device according to claim 2, wherein
the conductor pattern of the first coil has number of turns in accordance with output impedance of the primary circuit, and
the conductor pattern of the second coil has number of turns different from the first coil in accordance with. input impedance of the secondary circuit.

6. The power transmission device according to claim 2, wherein
the conductor pattern of the first coil has an outer diameter or an inner diameter in accordance with output impedance of the primary circuit, and
the conductor pattern of the second coil has an outer diameter or an inner diameter different from the first coil in accordance with input impedance of the secondary circuit.

7. The power transmission device according to claim 2, wherein
conductor patterns of the first coil. and the second coil have an outer diameter and an inner diameter substantially equal,
the conductor pattern of the first coil has a line width and number of turns in accordance with output impedance of the primary circuit, and
the conductor pattern of the second coil has a line width and number of turns different from the first coil in accordance with input impedance of the secondary circuit.

8. The power transmission device according to claim 2, wherein a conductor pattern of at least one of the first coil and the second coil has a line width in a section different from a line width in other sections.

9. The power transmission device according to claim 2, wherein
at least one of the first coil and the second coil has a plurality of conductor patterns each formed in a spiral-form,
the plurality of conductor patterns is connected in series inside the same conductor layer, and
a magnetic flux direction generated from each of the plurality of conductor patterns is substantially an opposite direction between conductor patterns disposed adjacent to each other.

10. The power transmission device according to claim 1, wherein the secondary circuit includes:
first smoothing capacitance connected to a first output node;
a third capacitance; and
a first diode bridge circuit configured to rectify power supplied from the output end of the second resonator via ice third capacitance and generate a first output. voltage in the first output node.

11. The power transmission device according to claim 10, wherein the secondary circuit further includes
second smoothing capacitance connected to a second output node; and
a second diode bridge circuit configured to rectify power supplied from the output end of the second resonator and generate second output voltage in the second output node.

12. The power transmission device according to claim 11, wherein the first output voltage is set in accordance with a capacitance value of the third capacitance.

13. The power transmission device according to claim 12, wherein
the secondary circuit further includes:
a first clamp circuit connected to the first output node and configured to control the first output voltage to predetermined voltage or less; and
a second clamp circuit connected to the second output node and configured to control the second output voltage to predetermined voltage or less.

14. The power transmission device according to claim 1, wherein the secondary circuit includes
a smoothing capacitance connected to an output node;
an impedance variable circuit;
a diode bridge circuit configured to rectify power supplied from the output end of the second resonator via the impedance variable circuit, and generate output voltage in the output node;
a voltage wave detector configured to detect the output voltage; and
a first control logic circuit configured to control an impedance value of the impedance variable circuit such that the voltage level detected by the voltage wave detector becomes a preset predetermined voltage level.

15. The power transmission device according to claim 2, wherein
the second capacitance included in the second resonator is variable capacitance, and
the secondary circuit includes:
smoothing capacitance connected to an output node;
a diode bridge circuit configured to rectify power supplied from the output end of the second. resonator and generate output voltage in the output node;
a voltage wave detector configured to detect the output voltage; and
a second control logic circuit configured to control a capacitance value of the second capacitance such that the voltage level detected by the voltage wave detector becomes a preset predetermined voltage level.
